(19) United States
(12) Patent Application Publication
(10) Pub. No.: US 2022/0002157 A1
(43) Pub. Date: Jan. 6, 2022

(54) GRAPHENE PRODUCTION IN AQUEOUS DISPERSION

(71) Applicant: The Lubrizol Corporation, Wicliffe, OH (US)

(72) Inventors: Thomas S. Corrigan, Lakewood, OH (US); Paul E. Adams, Willoughby, OH (US); John S. Manka, Liberty Township, OH (US); Eric Mock, Wickliffe, OH (US); Dean Thetford, Rochdale (GB)

(73) Assignee: The Lubrizol Corporation, Wickliffe, OH (US)

(21) Appl. No.: 17/292,616

(22) PCT Filed: Nov. 19, 2019
(86) PCT No.: PCT/US2019/062101

§ 371 Date: May 10, 2021

Related U.S. Application Data
(60) Provisional application No. 62/769,638, filed on Nov. 20, 2018.

(51) Int. Cl. C01B 32/19; C01B 32/194; C08L 33/24

(52) U.S. Cl. CPC C01B 32/19; C01B 32/194; B82Y 40/00; C01P 2004/24; C01P 2004/64; C08L 33/24

(57) ABSTRACT

The disclosed technology relates to the production of graphene by exfoliation in the presence of a dispersant, and the composition of graphene produced thereby.

### BACKGROUND OF THE INVENTION

The disclosed technology relates to the production of graphene by exfoliation in the presence of a dispersant, and the composition of graphene produced thereby.

Graphene can be viewed as a two dimensional sheet composed of sp² carbons in a six membered honeycomb structure. Graphene layers are the building blocks for all the other graphitic carbon allotropes. For example, graphite is composed of layers of graphene stacked one on top of another with an interlayer spacing of approximately 3.4 Angstroms. As another example, carbon nanotubes can be viewed as graphene layers rolled into tubes.

Graphene has very attractive physical, optical and mechanical properties, including high charge carrier mobility, high thermal conductivity and stiffness. It can be used for a wide range of applications, for example, in the electronics industry as well as for an additive in polymer production.

Various methods are known for the production of graphene. For example, layers of graphene can be exfoliated from graphite using adhesive tape or obtained by reducing layers of graphene oxide. Graphite can also be exfoliated in the liquid phase in an appropriate solvent. For example, U.S. Pat. No. 7,824,651 to Zhamu et al. (the “Zhamu patent”) describes a method of exfoliating a graphite material by ultrasonication in the presence of a surfactant or dispersant. The disclosure in the Zhamu patent on surfactants and dispersants is mostly generic, but it does call out a specific series of fluoro-surfactants as well as sodium hexametaphosphate, sodium lignosulphonate, sodium sulfate, sodium phosphate, and sodium sulfonate. The Zhamu patent does not teach nor suggest the dispersants disclosed in this application below. Similarly, US Publication No. 2016/0009561 to Coleman et al. (the “Coleman publication”) describes a method of exfoliating a 3-dimensional material, such as graphite, by shear force. The Coleman publication also mentions the use of surfactants generically, and calls out specifically sodium cholate, sodium dodecylsulphate, sodium dodecylbenzenesulphonate, lithium dodecyl sulphate, deoxycholate, taurodeoxycholate, polyoxyethylene (40) nonylphenyl ether, branched; and polyethylene glycol p-(1,1,3,3-tetramethylbutyl)-phenyl ether. As with Zhamu, Coleman does not teach nor suggest the dispersants disclosed in this application below.

The inventors have discovered that the use of certain dispersants disclosed herein can improve the yield and characteristics of graphene compositions produced by exfoliation processes.

### SUMMARY OF THE INVENTION

The disclosed technology, therefore, solves the problem of graphene platelet yield and production efficiency by employing certain dispersants in the graphene platelet exfoliation process.

The technology provides, among other things, a composition including a graphene platelet in an aqueous or polar solvent, along with a dispersant selected from at least one of
carboxyl containing interpolymers
derivatized polycarboxylate dispersant
imide polymers of formula (1):

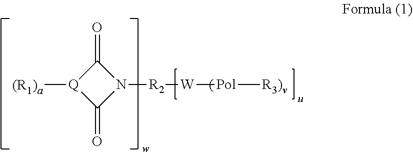

cycloaliphatic polyurethane resins wherein at least 60% by weight of the polyisocyanate resin component is characterized as a cycloaliphatic isocyanate and wherein having a poly(glycol adipate);
alkylene oxide polyurethane polymers;
water-dispersible or soluble dihydrocarbyl dithiophosphoric acid or salt having the formula II

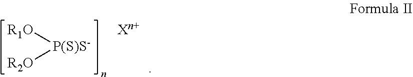

The graphene platelets can be mono-layer graphene, multi-layer graphene, and/or graphite nano-platelets. In some embodiments, the graphene platelets can have a carbon to oxygen molar ratio of greater than 25:1. In other embodiments, the graphene platelets can have a carbon to oxygen molar ratio of less than 20:1.

The technology also provides a process to produce the graphene platelet composition described above. The process includes blending a mixture of graphene platelets, at least one of the aforementioned dispersants, and an aqueous or polar solvent, and then subjecting the blend to mechanical or chemical exfoliation.

The mechanical exfoliation in the process can include shear mixing, ball milling, ultra-sonication or a combination of two or more of these techniques.

The disclosed technology provides a higher yield of suspended graphene platelets in a time and energy efficient manner.

### DETAILED DESCRIPTION OF THE INVENTION

Various preferred features and embodiments will be described below by way of non-limiting illustration.

As used herein, the term “graphene platelets” covers material that is essentially composed of a single sheet of graphene plane, also referred to as monolayer graphene, or multiple sheets of graphene stacked and bonded together, which also may be referred to as multi-layer graphene for platelets having from 2 to 10 layers, graphite nano-platelets for compositions having more than 10 layers of graphene plane, or graphite for compositions having more than 100 layers of graphene plane.

Graphite is a well-known compound and may be employed in the present technology in any of its various forms, including natural or synthetic, crystalline or amorphous. When used, graphite may be employed as flakes, powders, fibers or aggregates. The graphite may also be in the form of an intercalated compound having ions inserted between the oppositely charged carbon layers of the graphite. The graphite may also be in the form of a substituted graphite, such as graphene oxide or graphene fluoride

Substituted graphite, such as graphene oxide, is formed by the treatment of graphite with a substituent, such as oxidizing agents, and intercalants or other substituting means and has a high substituent content. Graphene oxide for example can have carbon to oxygen molar ratios of between about 2:1 and 25:1, or 1.5:1 and 20:1, or 1.25:1 and 15:1 or 1:1 and 5:1 to 10:1. As used herein, the term “carbon to oxygen ratio” refers to molar ratios of carbon to oxygen in the substituted graphite. Carbon to oxygen ratio is determined by elemental analysis and the resulting weight ratios are converted to molar ratios.

In some instances, it is preferred to employ a graphene platelet that is substantially free of substituents, such as oxygen, meaning a carbon to substituent ratio of 25:1 or greater, and preferably completely free of substituent.

Each graphene plane encompasses a two-dimensional hexagonal structure of carbon atoms. Each plate has a length and a width parallel to the graphene plane and a thickness orthogonal to the graphene plane. The thickness of a graphene platelet can be 100 nanometers (nm) or smaller and more typically thinner than 10 nm with a single-sheet graphene platelet being as thin as 0.34 nm. The length and width of a graphene platelet is typically between 1 μm and 20 μm, but could be longer or shorter. For certain applications, both length and width may be smaller than 1 μm.

The present technology includes a method for the production of graphene platelets. The process involves blending a graphene platelet, generally a graphite or graphite nano-platelet, but could also be a multi-layer graphene, in an aqueous or polar solvent with a dispersant, and subjecting the blend to an exfoliation process, either mechanical or chemical, to prepare a dispersion of graphene platelets, preferrably graphene, multi-layer graphene, or graphite nano-platelets, in water.

Exfoliation processes in general are also well known, as well as exfoliation of graphite in general. Example mechanical exfoliation processes include shearing (via stirring or shaking), milling, and sonication as well as supercritical fluid exfoliation. Chemical exfoliation may also be performed, for example, by chemical oxide reduction. Electro-chemical exfoliation may also be performed by applying an electrode to raw graphite in a solution with the dispersant, and applying a voltage.

The techniques disclosed herein are related to aqueous or polar dispersions, and any aqueous or polar solvent may be employed. The aqueous or polar solvent may, of course, be water, but may also be any polar solvent that may suspend graphene with the disclosed dispersants, such as for example alcohols, n-methyl pyrrolidone, DMF, ketones, such as acetone, and ethers.

While the general process of obtaining graphene platelets via exfoliation of a dispersion of graphite or graphene platelets may be generally known, it has been found that certain dispersants provide advantages in obtaining well-dispersed and exfoliated graphene platelets.

A class of dispersants that provides improved graphene platelet production are carboxyl containing interpolymers. Carboxyl containing interpolymers are prepared from monomers containing at least one activated >C═C< group and carboxyl group. Such polymers are homopolymers of an unsaturated, polymerizable carboxylic monomers such as acrylic acid, methacrylic acid, maleic acid, itaconic acid, maleic anhydride, and the like, and copolymers of polymerizable carboxylic monomers with acrylate esters, acrylamides, olefins, vinyl esters, vinyl ethers, or styrenics. The carboxyl containing interpolymers have molecular weights greater than about 500 to as high as several million, usually greater than about 10,000 to 900,000 or more.

Typical materials are those described in U.S. Pat. No. 2,798,053. Copolymers, for example, include copolymers of acrylic acid with small amounts of polyalkenyl polyether cross-linkers that are gel-like polymers, which, especially in the form of their salts, absorb large quantities of water or solvents with subsequent substantial increase in volume. Other useful carboxyl containing interpolymers are described in U.S. Pat. No. 3,940,351, directed to polymers of unsaturated carboxylic acid and at least one alkyl acrylic or methacrylic ester where the alkyl group contains 10 to 30 carbon atoms, and U.S. Pat. Nos. 5,034,486; 5,034,487; and 5,034,4087; which are directed to maleic anhydride copolymers with vinyl ethers. Other types of such copolymers are described in U.S. Pat. No. 4,062,817 wherein the polymers described in U.S. Pat. No. 3,940,351 contain additionally another alkyl acrylic or methacrylic ester and the alkyl groups contain 1 to 8 carbon atoms. Carboxylic polymers and copolymers such as those of acrylic acid and methacrylic acid also may be crosslinked with polyfunctional materials as divinyl benzene, unsaturated diesters and the like, as is disclosed in U.S. Pat. Nos. 2,340,110; 2,340,111; and 2,533,635. The disclosures of all of these U.S. patents are hereby incorporated herein by reference.

The carboxylic monomers are the olefinically-unsaturated carboxylic acids containing at least one activated carbon-to-carbon olefinic double bond, and at least one carboxyl group; that is, an acid or function readily convened to an acid containing an olefinic double bond which readily functions in polymerization because of its presence in the monomer molecule, either in the alpha-beta position with respect to a carboxyl group, —C═C—COOH; or as part of a terminal methylene grouping, CH₂═C<. Olefinically-unsaturated acids of this class include such materials as the acrylic acids typified by the acrylic acid itself, alpha-cyano acrylic acid, beta methylacrylic acid (crotonic acid), alpha-phenyl acrylic acid, beta-acryloxy propionic acid, cinnamic acid, p-chloro cinnamic acid, 1-carboxy-4-phenyl butadiene-1,3, itaconic acid, citraconic acid, mesaconic acid, glutaconic acid, aconitic acid, maleic acid, fumaric acid, and tricarboxy ethylene. As used herein, the term “carboxylic acid” includes the polycarboxylic acids and those acid anhydrides, such as maleic anhydride, wherein the anhydride group is formed by the elimination of one molecule of water from two carboxyl groups located on the same carboxylic acid molecule. Maleic anhydride and other acid anhydrides useful herein have the general structure

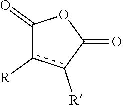

wherein R and R′ are selected from the group consisting of hydrogen, halogen and cyanogen (—C≡N) groups and alkyl, aryl, alkaryl, aralkyl, and cycloalkyl groups such as methyl, ethyl, propyl, octyl, decyl, phenyl, tolyl, xylyl, benzyl, cyclohexyl, and the like.

The preferred carboxylic monomers are the monoolefinic acrylic acids having the general structure

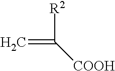

wherein R² is a substituent selected from the class consisting of hydrogen, halogen, and the cyanogen (—C≡N) groups, monovalent alkyl radicals, monovalent aryl radicals, monovalent aralkyl radicals, monovalent alkaryl radicals and monovalent cycloaliphatic radicals. Of this class, acrylic and methacrylic acid are most preferred. Other useful carboxylic monomers are maleic acid and its anhydride.

The interpolymers include both homopolymers of carboxylic acids or anhydrides thereof, or the defined carboxylic acids copolymerized with one or more other vinylidene monomers containing at least one terminal >CH₂ group. The other vinylidene monomers are present in an amount of less than 30 weight percent based upon the weight of the carboxylic acid or anhydride plus the vinylidene monomer(s). Such monomers include, for example, acrylate ester monomers including those acrylic acid ester monomers such as derivatives of an acrylic acid represented by the formula

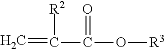

wherein R³ is an alkyl group having from 1 to 30 carbon atoms, preferably 1 to 20 carbon atoms and R₂ is hydrogen, methyl or ethyl, present in the copolymer in amount, for example, from about 1 to 40 weight percent or more. Representative acrylates include methyl acrylate, ethyl acrylate, propyl acrylate, isopropyl acrylate, butyl acrylate, isobutyl acrylate, methyl methacrylate, methyl ethacrylate, ethyl methacrylate, octyl acrylate, heptyl acrylate, octyl methacrylate, isopropyl methacrylate, 2-ethylhexyl methacrylate, nonyl acrylate, hexyl acrylate, n-hexyl methacrylate, and the like. Higher alkyl acrylic esters are decyl acrylate, isodecyl methacrylate, lauryl acrylate, stearyl acrylate, behenyl acrylate and melissyl acrylate. Mixtures of two or three or more long chain acrylic esters may be successfully polymerized with one of the carboxylic monomers. Other comonomers include olefins, including alpha olefins, vinyl ethers, vinyl esters, and mixtures thereof.

The interpolymers also may be cross-linked with any polyene, e.g. decadiene or trivinyl cyclohexane; acrylamides, such as methylene bis acrylamide; polyfunctional acrylates, such as trimethylol propane triacrylate; or polyfunctional vinylidene monomer containing at least 2 terminal CH₂< groups, including for example, butadiene, isoprene, divinyl benzene, divinyl naphthlene, allyl acrylates and the like. Particularly useful cross-linking monomers for use in preparing the copolymers are polyalkenyl polyethers having more than one alkenyl ether grouping per molecule. The most useful possess alkenyl groups in which an olefinic double bond is present attached to a terminal methylene grouping, CH₂═C<. They are made by the etherification of a polyhydric alcohol containing at least 2 carbon atoms and at least 2 hydroxyl groups. Compounds of this class may be produced by reacting an alkenyl halide, such as allyl chloride or allyl bromide, with a strongly alkaline aqueous solution of one or more polyhydric alcohols. The product may be a complex mixture of polyethers with varying numbers of ether groups. Analysis reveals the average number of ether groupings on each molecule. Efficiency of the polyether cross-linking agent increases with the number of potentially polymerizable groups on the molecule. It is preferred to utilize polyethers containing an average of two or more alkenyl ether groupings per molecule. Other cross-linking monomers include for example, diallyl esters, dimethallyl ethers, allyl or methallyl acrylates and acrylamides, tetraallyl tin, tetravinyl silane, polyalkenyl methanes, diacrylates, and dimethacrylates, divinyl compounds such as divinyl benzene, polyallyl phosphate, diallyloxy compounds and phosphite esters and the like. Typical agents are allyl pentaerythritol, allyl sucrose, trimethylolpropane triacrylate, 1,6-hexanediol diacrylate, trimethylolpropane diallyl ether, pentaerythritol triacrylate, tetramethylene dimethacrylate, ethylene diacrylate, ethylene dimethacrylate, triethylene glycol dimethacrylate, and the like. Allyl pentaerythritol, trimethylolpropane diallylether and allyl sucrose provide excellent polymers. When the cross-linking agent is present, the polymeric mixtures usually contain up to about 5% or more by weight of cross-linking monomer based on the total of carboxylic acid monomer, plus other monomers, if present, and more preferably about 0.01 to 3.0 weight percent.

In one aspect, the carbonyl containing interpolymer is a crosslinked homopolymer polymerized from acrylic acid or methacrylic acid and is generally referred to under the INCI name of Carbomer. Commercially available Carbomers include Carbopol® polymers 934, 940, 941, 956, 980, 981 and 996 available from Lubrizol Advanced Materials, Inc.

Other vinylidene monomers may also be used, including the acrylic nitriles. The useful α, β-olefinically unsaturated nitriles are preferably the monoolefinically unsaturated nitriles having from 3 to 10 carbon atoms such as acrylonitrile, methacrylonitrile, and the like. Most preferred are acrylonitrile and methacrylonitrile. The amounts used are, for example, for some polymers are from about 1 to 30 weight percent of the total monomers copolymerized. Acrylic amides containing from 3 to 35 carbon atoms including monoolefinically unsaturated amides also may be used. Representative amides include acrylamide, methacrylamide, N-t-butyl acrylamide, N-cyclohexyl acrylamide, higher alkyl amides, where the alkyl group on the nitrogen contains from 8 to 32 carbon atoms, acrylic amides including N-alkylol amides of alpha, beta-olefinically unsaturated carboxylic acids including those having from 4 to 10 carbon atoms such as N-methylol acrylamide, N-propanol acrylamide, N-methylol methacrylamide, N-methylol maleimide, N-methylol maleamic acid esters, N-methylol-p-vinyl benzamide, and the like. Still further useful materials are alpha-olefins containing from 2 to 18 carbon atoms, more preferably from 2 to 8 carbon atoms; dienes containing from 4 to 10 carbon atoms; vinyl esters and allyl esters such as vinyl acetate; vinyl aromatics such as styrene, methyl styrene and chlorostyrene; vinyl and allyl ethers and ketones such as vinyl methyl ether and methyl vinyl ketone; chloroacrylates; cyanoalkyl acrylates such as α-cyanomethyl acrylate, and the α-, β-, and γ-cyanopropyl acrylates; alkoxyacrylates such as methoxy ethyl acrylate; haloacrylates as chloroethyl acrylate; vinyl halides and vinyl chloride, vinylidene chloride and the like; divinyls, diacrylates and other polyfunctional monomers such as divinyl ether, diethylene glycol diacrylate, ethylene glycol dimethacrylate, methylene-bisacrylamide, allylpentaerythritol, and the like; and bis (β-haloalkyl) alkenyl phosphonates such as bis(β-chloroethyl) vinyl phosphonate and the like as are known to those skilled in the art.

In some embodiments, one is able to obtain an improved polymer which is easy to wet-out, disperse and handle, and yields good thickening efficiency by admixing a wetting additive with the interpolymer of a polycarboxylic acid and a steric stabilizing surfactant (or steric stabilizer). The steric stabilizer functions to provide a steric barrier which repulses approaching particles. A requirement for the steric stabilizer is that a segment of the dispersant (i.e., a hydrophobe) be very soluble in the solvent (the continuous phase in a nonaqueous dispersion polymerization process) and that another segment (i.e., a hydrophile) be at least strongly adhered to the growing polymer particle. Thus, the steric stabilizers of the present invention have a hydrophilic group and a hydrophobic group. The steric stabilizers are block copolymers comprising a soluble block and an anchor block having a molecular weight (i.e., chain length) usually well above 1000, but a hydrophobe length of more than 50 Angstroms, as calculated by the Law of Cosines. These dimensions are determined on the extended configuration using literature values for bond lengths and angles. Thus the steric stabilizers of the present invention are distinguishable from the prior art steric surfactants which may be block copolymers, but have hydrophobe lengths of less than 50 Angstroms. The steric stabilizer of the present invention has either a linear block or a comb configuration, and has a hydrophobe of sufficient length to provide a sufficient steric barrier.

When the steric stabilizer is a linear block copolymeric steric stabilizer, it is defined by the following formula:

C_{w}—(B-A-B_{y})ₓ-D_{z}

where A is a hydrophilic moiety, having a solubility in water at 25° C. of 1% or greater, a molecular weight of from about 200 to about 50,000, and selected to be covalently bonded to the B blocks; B is a hydrophobic moiety, having a molecular weight of from about 300 to about 60,000, a solubility of less than 1% in water at 25° C., capable of being covalently bonded to the A blocks; C and D are terminating groups which can be A or B; can be the same or different groups, and will depend upon the manufacturing process since they are present to control the polymer length, to add other functionality, or as a result of the manufacturing process; w is 0 or 1; x is an integer of 1 or more, y is 0 or 1, and z is 0 or 1.

Examples of hydrophilic groups are polyethylene oxide, poly(1,3-dioxolane), copolymers of polyethylene oxide or poly(1,3-dioxolane), poly(2-methyl-2-oxazoline polyglycidyl trimethyl ammonium chloride, polymethylene oxide, and the like, with polyethylene oxide being preferred. Examples of hydrophobic groups are polyesters, such as those derived from 2-hydroxybutyric acid, 3-hydroxybutyric acid, 4-hydroxybutyric acid, 2-hydroxycaproic acid, 10-hydroxydecanoic acid, 12-hydroxydodecanoic acid, 16-hydroxyhexadecanoic acid, 2-hydroxyisobutyric acid, 2-(4-hydroxyphenoxy) propionic acid, 4-hydroxyphenylpyruvic acid, 12-hydroxystearic acid, 2-hydroxyvaleric acid, polylactones, such as caprolactone, butyrolactone, polylactams, such as those derived from caprolactam, polyurethanes, polyisobutylene, where the hydrophobe should provide a steric barrier of greater than 50 Angstroms, preferably greater than 75 Angstroms, with greater than 100 Angstroms being also preferred, and the like, with polyhydroxy fatty acids, such as poly(12-hydroxystearic acid) being preferred. The steric barrier is the length of the hydrophobe in its fully-extended condition. Such steric stabilizers are commercially available under the brand name Hypermer® from Imperial Chemical Industries, Inc.

Steric stabilizer molecules comprise both hydrophilic and hydrophobic units. Hydrophobic polymer units or hydrophobic blocks may be prepared by a number of well known methods. These methods include condensation reactions of hydroxy acids, condensation of polyols (preferably diols) with polycarboxylic acids (preferably diacids). Other useful methods include polymerization of lactones and lactams, and reactions of polyols with polyisocyanates. Hydrophobic blocks or polymer units can be reacted with hydrophilic units by such reactions as are known to those skilled in the art. These reactions include condensation reactions and coupling reactions, for example. Subsequent to the steric stabilizer preparation, the stabilizers may be further reacted with modifying agents to enhance their utility. U.S. Pat. No. 4,203,877 to Alan S. Baker teaches making such steric stabilizers, and the entire disclosure thereof is incorporated herein by reference.

When the steric stabilizer is a random copolymeric comb steric stabilizer, it is defined by the following formula:

R₁—(Z)ₘ-(Q)ₙ-R₂,

where R₁ and R₂ are terminating groups and may be the same or different and will be different from Z and Q, Z is a hydrophobic moiety having a solubility of less than 1% in water at 25° C., Q is a hydrophilic moiety, having a solubility of more than 1% in water at 25° C., m and n are integers of 1 or more, and are selected such that the molecular weight of the polymer is from about 100 to about 250,000.

Examples of the hydrophobic monomer unit or moiety are dimethyl siloxane, diphenyl siloxane, methylphenyl siloxane, alkyl acrylate, alkyl methacrylate, and the like, with dimethyl siloxane being preferred.

Examples of the hydrophilic monomer unit or moiety are methyl-3-polyethoxypropyl siloxane-Ω-phosphate or sulfate, and the alkali metal or ammonium salts derived therefrom; traits derived from polyethoxy (meth)acrylate containing from 1 to 40 moles of ethylene oxide; acrylic acid; acrylamide; methacrylic acid, maleic anhydride; dimethyl amino ethyl (meth)acrylate; or its salts with methyl chloride or dimethyl sulfate; dimethyl amino propyl(meth)acrylamide and its salts with methyl chloride or dimethyl sulfate, and the like, with methyl-3-polyethoxypropyl siloxane-Ω-phosphate being preferred.

Examples of terminating agents are monohalo silanes, mercaptans, haloalkanes, alkyl aromatics, alcohols, and the like, which will produce terminating groups such as trialkyl silyl, alkyl, aryl alkyl, alcoholate, and the like, with the preferred terminating groups being trimethyl silyl.

An example of a random copolymeric comb steric stabilizer is a dimethicone copolyol phosphate which has the following formula:

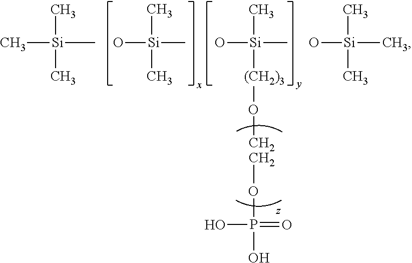

where x and y are integers greater than 1, and z is an integer from 1 to 100. Such a copolymeric comb steric stabilizer is available commercially under the trade name Pecosil from Phoenix Chemical, Somerville, N.J.

The steric stabilizers employed in the interpolymer have the potential for becoming part of a (meth)acrylic acid or anhydride-containing polymer as an interpolymer by several mechanisms, including a bonding mechanism, including graft-type polymerization, hydrogen bonding, olefinic unsaturation polymerization, or condensation reaction. The particular bonding mechanism theory is not relevant to the present invention, and is covered in copending U.S. patent application Ser. No. 07/935,616, now U.S. Pat. No. 5,288,814.

The wetting additive is preferably a low surface tension surfactant (or wetting aid) can be a fluorine containing, silicone containing or hydrocarbon surfactant, as long as it has an ability to reduce the surface tension of water (which is 72 dynes per centimeter at 25° C.), preferably to less than 40 dynes/era at 25° C., with less than 30 dynes/cm being further preferred. By the term hydrocarbon surfactant we mean any surfactant which contains carbon, hydrogen, and oxygen and does not contain fluorine or silicone molecules. The amount of low surface tension surfactant will usually be less than 10% by weight based upon the weight of the acrylic acid interpolymer or phr, although 0.001 phr to 5.0 phr is preferred. The exact amount will depend upon the surfactant which is selected and its ability to reduce the surface tension of water. Those surfactants which can be used at the least dosage, such as a fluorine containing surfactant are preferred. Further, it was unexpectedly discovered that some of the surfactants are quite effective at very low dosages, such that the surfactant has no or little effect on the properties of the interpolymer in its use as a thickener, emulsifier, or thickening aid. Although not fully understood, it is believed that some of the surfactants when used in greater doses will result in increased wetting times because the additional surfactant will provide an additional coating on the polymer particles and slow the wetting process.

The surfactants employed can be anionic, cationic, or nonionic with nonionic surfactants being preferred. When the surfactant is added pre-polymerization, the cationic and anionic nature of the surfactant can play a part in or influence the polymerization, while the nonionic surfactants remain relatively inactive, and continue to be present after the polymer is recovered and put into use.

The wetting additive can be added to the monomers in polymerizing the polycarboxylic acid interpolymer or after polymerization, or in the case of the low surface tension surfactants, it also can be added to the water into which the interpolymer is to be dispersed. It is preferred that the wetting additive be admixed after or post-polymerization. It is theorized that, when the surfactant is added during polymerization, it remains with the polymer as an admixture, but a portion of the surfactant is trapped in the interstices of the interpolymer, so the same amount added pre-polymerization will not be as effective as that amount added post-polymerization of the interpolymer. Further, there is nothing critical in the method of addition. For example, the surfactant can be added as a liquid to interpolymer while it is still in the polymerization solvent and before drying or it can be sprayed on the dry polymer powder which can then be subject to further drying.

The glycol and polyhydric alcohol are most preferably admixed after polymerization, and provide little or no benefit when added to the water into which the interpolymer is to be dispersed. It is reasoned that the presence of the alcohol functionality will interfere or interact with the acid functionality of the acid polymer being formed. When added to the polymer post-polymerization, it is possible to control the conditions, such as excessive heat when drying, which could lead to interference or interaction.

The polyhydric alcohols are organic hygroscopic compositions, usually alcohols, which facilitate the wetting of the interpolymer particles in water. For the purpose of this disclosure, we mean the term “polyhydric alcohols” is to include all hygroscopic alcohol compositions including glycols, such as polyethylene glycol. The use of either a low surface tension surfactant or a polyhydric alcohol benefits the wetting of the polymer particles by aiding the wetting of the water by lowering the surface tension of the water and allowing it to penetrate the polymer particle or by drawing the particle to the water (or the water to the particle) via the hygroscopic mechanism. As will be seen either benefits the wetting of the polymer without detriment to the use of the polymer as, e.g., a thickener.

The preferred polyhydric alcohols are glycerin (or glycerol). The preferred glycol is low molecular weight polyethylene glycol. Other polyhydric alcohols (or polyols) or glycols can be employed.

The carboxyl containing interpolymer can also be a copolymer, terpolymer, or other interpolymer of alpha, beta-unsaturated dicarboxylic acids or derivatives thereof, and one or more vinyl aromatic monomers having up to 12 carbon atoms. The derivatives of the dicarboxylic acid are derivatives which are polymerizable with a monoolefinic compound, and as such, may be the anhydrides of the acids. Copolymers of maleic anhydride and styrene are especially suitable.

Suitable alpha, beta-unsaturated dicarboxylic acids, anhydrides thereof useful in the preparation of the interpolymers include those wherein a carbon-to-carbon double bond is in an alpha, beta-position to at least one of the carboxy functions (e.g., itaconic acid, anhydride thereof) and preferably, in an alpha, beta-position to both of the carboxy functions of the alpha, beta-dicarboxylic acid, anhydride thereof (e.g., maleic acid, anhydride thereof). Normally, the carboxy functions of these compounds will be separated by up to 4 carbon atoms, preferably 2 carbon atoms.

A class of preferred alpha, beta-unsaturated dicarboxylic acid, anhydride thereof, includes those compounds corresponding to the formulae:

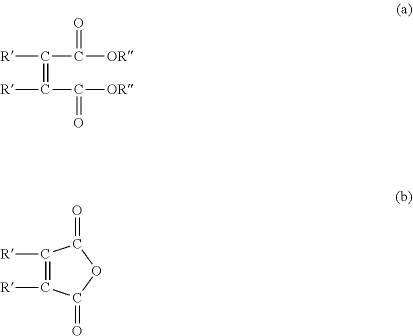

(including the geometric isomers thereof, i.e., cis and trans) wherein each R′ is independently hydrogen; halogen (e.g., chloro, bromo, or iodo); hydrocarbyl or halogen-substituted hydrocarbyl of up to about 8 carbon atoms, preferably alkyl, alkaryl or aryl; (preferably, at least one R′ is hydrogen); and each R″ is independently hydrogen or lower alkyl of up to about 7 carbon atoms (e.g., methyl, ethyl, butyl or heptyl). These preferred alpha, beta-unsaturated dicarboxylic acids, anhydrides thereof contain a total carbon content of up to about 25 carbon atoms, normally up to about 15 carbon atoms. Maleic anhydride and maleic acid are preferred. Maleic anhydride is most preferred. Interpolymers derived from mixtures of two or more of any of these can also be used.

Suitable vinyl aromatic monomers of up to about 12 carbon atoms which can be polymerized with the alpha, beta-unsaturated dicarboxylic acids, anhydrides thereof are well known. The vinyl aromatic compounds include styrene and substituted styrenes such as 4-methylstyrene, halostyrenes, para-tert-butyl styrenes and para-lower alkoxy styrene. Styrene is the most preferred vinyl aromatic monomer. Interpolymers derived from mixtures of two or more of any of these can also be used.

Of the interpolymers of this invention, the styrene-maleic anhydride interpolymers are especially useful. They are obtained by polymerizing styrene with maleic anhydride at molar ratios from (5:1) to (0.75:1), with (2.5:1) to (1:1) being preferred,—and (1:1) being most preferred.

A further embodiment may be obtained by polymerizing an additional comonomer with the vinyl aromatic monomer and the alpha, beta-unsaturated dicarboxylic anhydride or acid. The additional comonomer may be: methacrylic acid; methacrylamide; itaconic acid and anhydride; citraconic acid and anhydride; isobutylene and its oligomers; diisobutylene and methylstyrene isomers. Alpha-methylstyrene and methacrylic acid are preferred; methacrylic acid is most preferred. These comonomers are present in relatively minor portions, i.e., less than about 0.3 mole, usually less than 0.15 mole, per mole of either the olefin (e.g. styrene) or the alpha, beta-unsaturated acid or anhydride (e.g. maleic anhydride). Terpolymers of styrene and maleic anhydride are preferred.

The interpolymer of alpha, beta-unsaturated dicarboxylic acids or derivatives thereof, and one or more vinyl aromatic monomers may then be treated with a base to neutralize the acidic catalyst. A mineral base or an amino compound may be used to neutralize the acidic catalyst. Examples of the mineral base include sodium hydroxide, calcium hydroxide and the like, with sodium hydroxide preferred. Example amino compounds can include ammonium (NH₄) and the like.

Another class of dispersants that provides improved graphene platelet production are derivatized polycarboxylate dispersants, which are derivatized polymers comprising a backbone having moieties derived from (a) an unsaturated hydrocarbon; (b) at least one of a substituted carboxylic acid monomer, a substituted ethylenically unsaturated monomer, and maleic anhydride; and (c) optionally including an N-polyoxyalkylene succinimide; and wherein derivative moieties are pendant to the backbone monomer by at least one ester linkage and at least one amide linkage. The derivatized polycarboxylate dispersant is a random copolymer of the general structural units shown below:

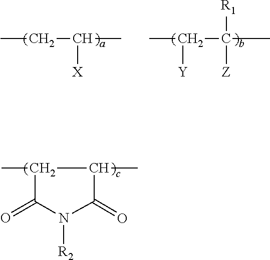

wherein:
the “b” structure is one of a substituted carboxylic acid monomer, a substituted ethylenically unsaturated monomer, and maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
X=H, CH₃, C₂ to C₆ Alkyl, Phenyl, or Substituted Phenyl such as p-Methyl Phenyl, p-Ethyl Phenyl, Carboxylated Phenyl, Sulfonated Phenyl and the like;
Y=H, —COOM, —COOH, or W;
W=a hydrophobic defoamer represented by the formula R₅—(CH₂CH₂O)ₛ—(CH₂C(CH₃)HO)ₜ—(CH₂CH₂O)ₙ where s, t, and u are integers from 0 to 200 with the proviso that t>(s+u) and wherein the total amount of hydrophobic defoamer is present in an amount less than about 10% by weight of the derivatized polycarboxylate dispersant;
Z=H, —COOM, —OR₃, —COOR₃, —CH₂OR₃, or —CONHR₃;
R₁=H, or CH₃;
R₂, R₃, are each independently a random copolymer of oxyethylene units and oxypropylene units of the general formula —(CH₂C(R₁)HO)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₈ alkyl or C₆ to C₁₈ alkyl aryl;
M=Alkali Metal, Alkaline Earth Metal, Ammonia, Amine, Substituted Amine such as monoethanol amine, diethanol amine, triethanol amine, morpholine, imidazole and the like;
a=0.01-0.8, preferably 0.01-0.6, and most preferably 0.01-0.5;
b=0.2-0.99, preferably 0.3-0.99, and most preferably 0.4-0.99;
c=0-0.5, preferably 0-0.3, and most preferably 0-0.1; and
   wherein a, b, c represent the mole fraction of each unit and the sum of a, b, and c, is 1.

Preferably, the “a” structure includes a styrene moiety.

The alkali metal in the dispersant is preferably lithium, sodium, or potassium. The alkaline earth metal in the dispersant is preferably magnesium or calcium.

Representative monomers for the “a” component include, but are not limited to, styrene, ethylene, propylene, or sulfonated styrene. Representative monomers for the “b” component include, but are not limited to, acrylic acid, methacrylic acid, alkyl esters of acrylic acid, alkyl esters of methacrylic acid, alkoxypolyoxyalkylene esters of acrylic acid, alkoxypolyoxyalkylene esters of methacrylic acid, maleic acid, vinyl sulfonic acid, methoxypolyoxyalkylene vinyl ether, methoxypolyoxyalkylene allyl ether, alkoxypolyoxyalkylene vinyl ether, or alkoxypolyoxyalkylene allyl ether.

Component “c” can be formed from a post reaction from the grafting of the side chains onto the polymer backbone such as a polyacrylate or maleic anhydride copolymer. The reaction to form component “c” is related to the temperature of the grafting reaction. If the temperature is high enough, the imide (succinimide) component “c” is formed. Component “c” is formed from a single monomer which is a component “b” with Y as COOH and Z as CONHR₃. A condensation reaction occurs wherein water condenses and the ring closes to form component “c”.

The derivatized polycarboxylate dispersant preferably includes a hydrophobic substituent functioning as a defoamer. The hydrophobic defoamer is present in an amount less than about 10% by weight of the derivatized polycarboxylate dispersant, and is preferably present in an amount less than about 5%. Besides being grafted or chemically linked onto the derivatized polycarboxylate dispersant by attaching via an ester linkage to a “b” group in the polymer structure above, the hydrophobic defoamer can be formulated into a mixture with the derivatized polycarboxylate dispersant. When grafted or chemically linked onto the defoamer is represented by the following formula (which is represented by “W” in the above polymer structure): R₅—(CH₂CH₂O)ₛ—(CH₂C(CH₃)HO)ₜ—(CH₂CH₂O)ₙ where s, t, and u are integers from 0 to 200 with the proviso that t>(s+u) and where R₅ is a C₁ to C₁₈ alkyl or C₆ to C₁₈ alkyl aryl. The total of hydrophobic defoamer, which is either grafted or chemically linked onto the derivatized polycarboxylate dispersant or is formulated into a mixture with the derivatized polycarboxylate dispersant, is present in an amount less than about 10% by weight of the derivatized polycarboxylate dispersant.

The following defoamers are examples of hydrophobic defoamers that can be formulated into the polymer solution: polyoxyalkylene glycols, such as those sold under the trademark PLURONIC from BASF, acetylene glycols, and alkoxylated acetylene alcohols, such as those sold under the trademark SURFYNOL from Air Products, fatty acid alkoxylates, such as alkoxylated lauric or oleic acid, or alkoxylated fatty amines, such as an alkoxylated lauric or oleylamine formulated defoamers. These defoamers can be added alone or in combination.

Incorporation of amide or imide linkages between the copolymer, such as styrene-maleic main chain polymer, and the alkoxy polyoxyalkylene side chain can improve the chemical and performance stability of graft polymer solutions. Incorporation of nitrogen based linkages between main chain and side chain stabilizes side chain degrafting that slowly occurs with maleic mono ester linkages during solution storage.

It is not necessary that all linkages between the side chain and polymer backbone be through an amide or imide nitrogen. On the contrary, it is preferred that the linkages be mixed between ester (or oxygen) and amide or imide. The combination of ester (or oxygen) and amide or imide linkages improves the long term performance, for example stability, of the polymer solution and lowers the cost relative to the all amide or imide pendant linkages.

Example derivatized polycarboxylate dispersants include, but are in no way limited by, methoxy polyoxyalkylene glycols and methoxy polyoxyalkylene amine.

The polymers used in the derivatized polycarboxylate dispersant can be made by methods known in the art, such as those referenced in U.S. Pat. Nos. 5,661,206; 5,393,343; 5,158,996; 5,047,087; 4,972,025; 4,968,734; 4,463,406; and 4,471,100 all of which are hereby incorporated by reference herein as if fully written out below.

Specific nonlimiting examples of synthesizing the derivatized polycarboxylate dispersants are described below.

Derivatized Polycarboxylate Synthesis Example Number 1

Sixteen grams of styrene maleic anhydride (SMA), SMA-1000 from Atochem with a 2500 MW, was dissolved in 53.1 g of tetrahydrofuran (THF). Next, 39.6 g of methoxy polyoxyalkylene amine, XTJ-506 from Huntsman Corporation with a 1000 MW, and 4.8 g of triethyl amine were dissolved in 60.6 g of THF. The amine solution was drip fed into the stirring SMA solution over a period of about 30 minutes. The mixture was stirred for about 45 minutes at room temperature then heated to about 45° C. The mixture was reacted for about 2 hours. The THF solvent was removed from the mixture and the mixture was dried to a constant weight leaving polymer. The polymer was dissolved in an aqueous caustic solution and the resulting solution was adjusted to about 40% solids and a pH of about 7.0.

Derivatized Polycarboxylate Synthesis Example Number 2

One hundred grams of styrene maleic anhydride (SMA), SMA-1000 from Atochem with a 2500 MW, was dissolved in 310 g of tetrahydrofuran (THF). Next, 321 g of methoxy polyoxyalkylene amine, XTJ-508 from Huntsman Corporation, was delivered to the stirring SMA solution over a period of about 45 to about 60 minutes under nitrogen pressure. The mixture was heated to about 45° C. and reacted for about 1 hour. The THF solvent was removed from the mixture and the mixture was dried to a constant weight leaving polymer. The polymer was dissolved in an aqueous caustic solution and the resulting solution was adjusted to about 40% solids and a pH of about 7.0.

Derivatized Polycarboxylate Synthesis Example Number 3

One hundred twenty-eight grams of styrene maleic anhydride (SMA), SMA-1000 from Atochem with a 2500 MW, was dissolved in 128 g of methyl isobutyl ketone (MIBK) under nitrogen pressure and stirring at 100° C. An addition of a mixture comprising 53 g of methoxy polyoxyethylene glycol (mPEG-OH) with a 1100 MW and 1 g of dimethylaminopyridine (DMAP) was added to the stirring SMA solution. This addition was followed by 50.25 g of methoxy polyoxyalkylene amine, XTJ-508 from Huntsman Corporation with a 2000 MW, to the SMA solution. Three more identical additions of mPEG-OH/DMAP followed by methoxy polyoxyalkylene amine were added to the stirring SMA solution. The resulting mixture was reacted for about 4.5 hours. The MIBK solvent was removed from the mixture and the mixture was dried to a constant weight leaving polymer. The polymer was dissolved in an aqueous caustic solution and the resulting solution was adjusted to about 40% solids and a pH of about 7.0.

Derivatized Polycarboxylate Synthesis Example Number 4

Six and four tenths grams of styrene maleic anhydride (SMA), SMA-1000 from Atochem with a 2500 MW, was dissolved in 9.4 g of methyl isobutyl ketone (MIBK) under nitrogen atmosphere and stirring at 100° C. Next, 15.9 g of methoxy polyethylene glycol (mPEG-OH) with a 1100 MW and 0.2 g of dimethylaminopyridine (DMAP) were added to the stirring SMA solution. The resulting mixture was reacted for about 4.5 hours. The MIBK solvent was removed from the mixture and the mixture was dried to a constant weight leaving polymer. The polymer was dissolved in an aqueous caustic solution and the resulting solution was adjusted to about 40% solids and a pH of about 7.0.

A further class of dispersants that provides improved graphene platelet production are imide containing polymer polymers comprising a polymer chain having at least one fused aromatic imide pendant group, wherein the polymer is represented by formula (1)

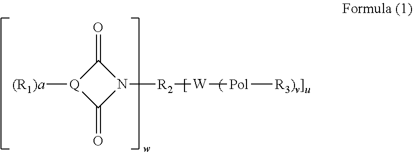

wherein each variable may independently be:
R₁ may be a substituent on Q ring in any position available for bonding to a substituent group and R₁ is independently represented by at least one electron withdrawing group. Electron withdrawing groups are well known to a person skilled in the art of organic synthesis. Examples of electron withdrawing groups include but are not limited to a halogen (such as —CI, —Br, or —F), a nitrile, a carbonyl group, a nitro group, a sulphamoyl group, a sulphonate group, a hydroxy group, or an amino group. The electron withdrawing group may be either an activating group or a deactivating group. The activating group may include a hydroxy group, an amino group, or a halogen. Typically, the activating group may include halogen such as —Cl or —Br. The deactivating group may include a nitrile, a carboxyl group, a nitro group, a sulphamoyl group, or a sulphonate group. Typically, the deactivating group may include a nitro group, a carboxyl group or a sulphonate group. Typically, the electron withdrawing group may be deactivating group. Example electron withdrawing groups for R₁ can include, but not be limited to —CN, —NO₂, —SO₂NR′2, —C(O)R′, —SO₃M, —C(O)OM, halo e.g., —Cl or —Br, —NH₂> or —OR′). Typically, R₁ may be —CI, —SO₃M or —NO₂;
component “a” may be 1 or 2, or 1;
M may be H, a metal cation, —NR′₄⁺, or mixtures thereof;
R′ may be —H or an optionally-substituted alkyl, typically, containing 1 to 20, or 1 to 10 carbon atoms, and the substituents may be hydroxyl or halo (typically Cl) or mixtures thereof;
R₂ may be a C₁ to C₂₀, or C₁ to C₁₂, or C₁ to C₆ hydrocarbylene group or a C₁ to C₂₀, or C₁ to C₁₂, or C₁ to C₆ hydrocarbonylene group (when R₂ contains more than 2 carbon atoms, the hydrocarbylene group or hydrocarbonylene group may be linear or branched), or mixtures thereof;
R₃ may be H or C₁₋₅₀ (or C₁₋₂₀)-optionally substituted hydrocarbyl group that bonds to a terminal oxygen atom of the polymer chain forming a terminal ether or terminal ester group and may or may not contain a group capable of polymerization such as a vinyl group, or C₁₋₅₀ (or C₁₋₂₀)-hydrocarbonyl group (i.e., a hydrocarbyl group containing a carbonyl group) that bonds to the oxygen atom of the polymer chain forming a terminal ester group or terminal urethane group and may or may not contain a group capable of polymerization such as a vinyl group, and the substituent may be halo, ether, ester, or mixtures thereof;
Pol may be a homopolymer chain of ethylene oxide or a copolymer chain of ethylene oxide, wherein the ethylene oxide constitutes 40 wt % to 99.99 wt % of the copolymer chain;
u may be 1 to 3, or 1 to 2, or 1;
v may be 1 to 2;
w may be 1 to 3 or 1 to 2, or 1;
v=1 when W=Oxygen, Sulphur, or >NG; G may be a hydrocarbyl group containing 1 to 200, or 1 to 100, or 1 to 30 carbon atoms;
v=2 when W=>NG; and

Q may be a fused aromatic ring containing 4n+2 it-electrons, wherein n=2 or more, typically 2 to 5, or 2 to 4, or 2 to 3, or 2), and Q is bonded to the imide group in such a way to form a 5 or 6 membered imide ring (typically 6 membered).

In one embodiment, Pol may be a copolymer of ethylene oxide and at least one member of the group consisting of an alkylene glycol containing 3 or more carbon atoms (typically 3 to 24, or 3 to 8, or 3 to 4, or 3 carbon atoms, typically, propylene oxide), styrene oxide, a lactone, a hydroxy-C₂₋₂₀-alk(en)ylene carboxylic acid, and mixtures thereof. Pol based on a copolymer of ethylene oxide and a lactone, a hydroxy-C₂₋₂₀-alk(en)ylene carboxylic acid or a mixture thereof may be defined as a copolymer of a poly(ethylene oxide) and a poly(ester) or a copolymer of poly(ether) and poly(ester).

Examples of an alkylene glycol containing 3 or more carbon atoms include propylene glycol, butylene glycol, or mixtures thereof, (typically, propylene glycol).

Examples of a hydroxy-C₂₋₂₀-alk(en)ylene carboxylic acid include ricinoleic acid, 12-hydroxy stearic acid, 6-hydroxy caproic acid, 5-hydroxy valeric acid, 12-hydroxy dodecanoic acid, 5-hydroxy dodecanoic acid, 5-hydroxy decanoic acid, 4-hydroxy decanoic acid, 10-hydroxy undecanoic acid, lactic acid glycolic acid, or mixtures thereof.

Examples of a lactone include β-propiolactone, γ-butyrolactone, optional alkyl substituted ε-caprolactone and optionally alkyl substituted δ-valerolactone. The alkyl substituent in ε-caprolactone and δ-valerolactone may be C₁₋₆-alkyl, or C₁₋₄-alkyl, and may be linear or branched. Examples of suitable lactones are ε-caprolactone and the 7-methyl-, 2-methyl-, 3-methyl-, 5-methyl-, 6-methyl-, 4-methyl-, 5-tertbutyl-, 4,4,6-trimethyl- and 4,6,6-trimethyl-analogues thereof.

In one embodiment, the polymer (typically represented by formula (1)) may be obtained/obtainable by a process comprising reacting an amine ended polymer with a fused aromatic di-acid or anhydride or other acid-forming derivative (such as di-ester, di-amide, di-acid dichloride) to form a fused aromatic imide with a polymer chain. The reaction to form the imide may be carried out at a sufficiently high temperature known to the skilled person to favor imide formation e.g., at least 100° C., or 150° C. to 200° C.

In one embodiment, the polymer (typically represented by formula (1)) may be obtained/obtainable by a process comprising:

Step (1): reacting (i) amino acid or (ii) an aminoalcohol, or (iii) an aminothiol, or (iv) a diamine or polyamine, with a fused aromatic di-acid or anhydride or other acid-forming derivative (such as di-ester, di-amide, di-acid dichloride) to form an acid-functionalized fused aromatic imide or a hydroxyl-functionalized fused aromatic imide, or a thiol-functionalized fused aromatic imide, or an aminofunctionalized fused aromatic imide respectively. The first step of the reaction (to form the imide) may be carried out at a sufficiently high temperature known to the skilled person to favor imide formation e.g., at least 100° C., or 150° C. to 200° C.;

Step (2): reacting the acid-functionalized fused aromatic imide or the hydroxyl-functionalized fused aromatic imide, or the thiol-functionalized fused aromatic imide, or the amino-functionalized fused aromatic imide with a polymer chain, or monomers that polymerize to form the polymer chain, wherein the polymer chain is a homopolymer chain of ethylene oxide or a copolymer chain of ethylene oxide, and wherein the ethylene oxide constitutes 40 wt % to 99.99 wt % of the copolymer chain.

The product of Step (1) may be used as a polymerization terminating agent if the polymer chain has been pre-formed before reaction in Step (2).

The product of Step (1) may be used as a polymerization initiator if the polymer chain is grown from one or more monomers in Step (2).

When the product of Step (1) is further reacted in an alkoxylation reaction, the reaction temperature may be 100° C. to 200° C. in the presence of a base catalyst such as potassium hydroxide or sodium hydroxide.

When the product of Step (1) or Step (2) is further reacted in an esterification reaction, the reaction temperature may be 50° C. to 250° C. or 150° C. to 200° C., optionally in the presence of an esterification catalyst.

The esterification catalyst may be any previously known to the art and include tin(II) octanoate, tetra-alkyl titanate, for example, tetrabutyltitanate, zinc salt of an organic acid, for example, zinc acetate, zirconium salt of an aliphatic alcohol, for example, zirconium isopropoxide, toluene sulphonic acid or a strong organic acid such as trifluoroacetic acid, or phosphoric acid.

The polymer of formula (1) may be capped with an R₃ group (other than H). The R₃ group may be derived from a carboxylic acid, an acid derivative, an alcohol or an isocyanate. The acid, acid derivative, alcohol and isocyanate are described herein below. The reaction conditions for capping the polymer chain to result in the polymer with an acid, an acid derivative, an alcohol or an isocyanate are reactions known in the art.

The process may be carried out in an inert atmosphere provided by any inert gas of the Periodic Table but typically nitrogen. The process may be carried out in a melt, or in the presence or absence of solvent. The solvent may be a non-polar solvent (such as an aromatic or aliphatic compound), a polar organic solvent or water. The solvents are well known in the art.

The imide containing polymer dispersants described above may be employed at levels of from about 0.01 to about 2 wt %, or from about 0.05 to about 1.5 wt %, or even from about 0.1 to about 1 wt %. In some instances, the imide containing polymer may be employed at about 0.2 to about 0.5 wt %.

The dispersant can be a polyurethane prepolymer formed from at least one polyisocyanate, at least one active hydrogen-containing compound and, optionally, at least one water-dispersibility enhancing compound.

### Definitions

In this document, “polyurethane” is a generic term used to describe polymers including oligomers (e.g., prepolymers) which contain the urethane group, i.e.,

—O—C(═O)—NH—,

regardless of how the polymers are made. As well known, these polyurethanes can contain additional groups such as urea, allophanate, biuret, carbodiimide, oxazolidinyl, isocynaurate, uretdione, etc. (that were formed during the polymer synthesis) in addition to urethane groups.

“Wt.%” means the number of parts by weight of monomer per 100 parts by weight of polymer, or the number of parts by weight of ingredient per 100 parts by weight of composition or material of which the ingredient forms a part.

“Aqueous medium” means a composition containing a substantial amount of water. It may contain other water soluble and/or water dispersible ingredients as well.

The “final polyurethane product” refers to the form of the polyurethane in an aqueous dispersion product or the polyurethane in the dried image. Where the polyurethane prepolymer is optionally chain extended, the final polyurethane product is this chain extended polymer. Where the polyurethane prepolymer is not chain extended, the final polyurethane product is the prepolymer itself. When the polyurethane is partially or fully crosslinked before or after exiting the ink jet nozzle, the polyurethane product can be the crosslinked polyurethane. In a preferred embodiment, the polyurethane exists as a dispersed oleophilic phase within a water based medium. The dispersed phase is desirably colloidally stabilized by ionic segments on the polyurethane such as those derived from hydroxy-carboxylic acids.

“Substantial absence of water” refers to compositions formed without the intentional addition of any significant amount water, e.g., about 2 wt. % or so.

Polyisocyanate

Suitable polyisocyanates have an average of about two or more isocyanate groups, preferably an average of about two to about four isocyanate groups per molecule and include aliphatic, cycloaliphatic, araliphatic, and aromatic polyisocyanates, as well as products of their oligomerization, used alone or in mixtures of two or more.

Diisocyanates are more preferred.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates include dicyclohexylmethane diisocyanate, (commercially available as Desmodur™ W from Bayer Corporation), isophorone diisocyanate, 1,4-cyclohexane diisocyanate, 1,3-bis-(isocyanatomethyl) cyclohexane, and the like. Preferred cycloaliphatic polyisocyanates include dicyclohexylmethane diisocyanate (most preferred) and isophorone diisocyanate. In one preferred embodiment, at least 50, more desirably at least 75, and preferably at least 85 mole % of the polyisocyanate used in reacting a polyisocyanate with an active-hydrogen containing compound to form a urethane polymer or prepolymer is a cycloaliphatic polyisocyanate and preferably dicyclohexylmethane diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate, toluene diisocyanate, their isomers, naphthalene diisocyanate, and the like. A preferred aromatic polyisocyanate is toluene diisocyanate.

Active Hydrogen-Containing Compounds

Any compound that provides a source of active hydrogen for reacting with isocyanate groups via the following reaction: —NCO+H—X—>—NH—C(═O)—X, can be used as the active hydrogen-containing compound. Examples include but are not limited to polyols, polythiols and polyamines.

“Polyol” in this context means any product having an average of about two or more hydroxyl groups per molecule. Examples include low molecular weight products called “extenders” with number average molecular weight less than about 500 Dalton such as aliphatic, cycloaliphatic and aromatic polyols, especially diols, having 2-20 carbon atoms, more typically 2-10 carbon atoms, as well as “macroglycols,” i.e., polymeric polyols having molecular weights of at least 500 Daltons, more typically about 1,000-10,000 Daltons, or even 1,000-6,000 Daltons. Examples of such macroglycols include polyester polyols including alkyds, polyether polyols, polycarbonate polyols, polyhydroxy polyester amides, hydroxyl-containing polycaprolactones, hydroxyl-containing acrylic polymers, hydroxyl-containing epoxides, polyhydroxy polycarbonates, polyhydroxy polyacetals, polyhydroxy polythioethers, polysiloxane polyols, ethoxylated polysiloxane polyols, polybutadiene polyols and hydrogenated polybutadiene polyols, polyisobutylene polyols, polyacrylate polyols, halogenated polyesters and polyethers, and the like, and mixtures thereof. The polyester polyols, polyether polyols, polycarbonate polyols, polysiloxane polyols, and ethoxylated polysiloxane polyols are preferred. The polyester polyols are most preferred.

The polyester polyols typically are esterification products prepared by the reaction of organic polycarboxylic acids or their anhydrides with a stoichiometric excess of a diol or diols. Examples of suitable polyols for use in the reaction include poly(glycol adipate)s, poly(ethylene terephthalate) polyols, polycaprolactone polyols, alkyd polyols, orthophthalic polyols, sulfonated and phosphonated polyols, and the like, and mixtures thereof.

The diols used in making the polyester polyols include alkylene glycols, e.g., ethylene glycol, 1,2- and 1,3-propylene glycols, 1,2-, 1,3-, 1,4-, and 2,3-butylene glycols, hexane diols, neopentyl glycol, 1,6-hexanediol, 1,8-octanediol, and other glycols such as bisphenol-A, cyclohexane diol, cyclohexane dimethanol (1,4-bis-hydroxymethylcycohexane), 2-methyl-1,3-propanediol, 2,2,4-trimethyl-1,3-pentanediol, diethylene glycol, triethylene glycol, tetraethylene glycol, polyethylene glycol, dipropylene glycol, polypropylene glycol, dibutylene glycol, polybutylene glycol, dimerate diol, hydroxylated bisphenols, polyether glycols, halogenated diols, and the like, and mixtures thereof. Preferred diols include ethylene glycol, diethylene glycol, butylene glycol, hexane diol, and neopentyl glycol.

Suitable carboxylic acids used in making the polyester polyols include dicarboxylic acids and tricarboxylic acids and anhydrides, e.g., maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, and mixtures thereof. Preferred polycarboxylic acids used in making the polyester polyols include aliphatic or aromatic dibasic acids.

Particularly interesting polyols are the polyester diols, i.e., any compound containing the —C(═O)—O— group. Examples include poly(butanediol adipate), poly(caprolactone)s, acid-containing polyols, polyesters made from hexane diol, adipic acid and isophthalic acid such as hexane adipate isophthalate polyester, hexane diol neopentyl glycol adipic acid polyester diols, e.g., Piothane 67-3000 HNA (Panolam Industries) and Piothane 67-1000 HNA; as well as propylene glycol maleic anhydride adipic acid polyester diols, e.g., Piothane 50-1000 PMA; and hexane diol neopentyl glycol fumaric acid polyester diols, e.g., Piothane 67-500 HNF. Other preferred polyester diols include Rucofiex™. S1015-35, S1040-35, and S-1040-110 (Bayer Corporation). In one preferred embodiment, at least 50, more desirably at least 75, and preferably at least 85 mole % of the active-hydrogen containing compound used in reacting a polyisocyanate with an active-hydrogen containing compound to form the urethane polymer or prepolymer is a polyester from aliphatic linear and branched diols reacted with adipic acid and preferably a copolymer of 1,6-hexane diol, neopentyl glycol, and adipic acid. In one embodiment the mole ratio of 1,6-hexane diol to neopentyl glycol in the copolymer is 90:10 to 10:90, in another embodiment the ratio is 75:25 to 25:75. In one embodiment at least 90 mole % of the acid in said copolymer is adipic acid. In one embodiment at least 90 mole % of the diol in said copolymer is 1,6-hexane diol or neopentyl glycol.

The polyether polyols that can be used as the active hydrogen-containing compound contain the —C—O—C— group. They can be obtained in a known manner by the reaction of (A) the starting compounds that contain reactive hydrogen atoms, such as water or the diols set forth for preparing the polyester polyols, and (B) alkylene oxides, such as ethylene oxide, propylene oxide, butylene oxide, styrene oxide, tetrahydrofuran, epichlorohydrin, and the like, and mixtures thereof. Preferred polyethers include poly(propylene glycol), polytetrahydrofuran, and copolymers of poly(ethylene glycol) and poly(propylene glycol).

Polycarbonate polyols include those containing the —O—C(═O)—O— group. They can be obtained, for example, from the reaction of (A) diols such 1,3-propanediol, 1,4-butanediol, 1,6-hexanediol, diethylene glycol, triethylene glycol, tetraethylene glycol, and the like, and mixtures thereof with (B) diarylcarbonates such as diphenylcarbonate or phosgene. Aliphatic and cycloaliphatic polycarbonate polyols can also be used. In one preferred embodiment, at least 50, more desirably at least 75, and preferably at least 85 mole % of the active-hydrogen containing compound used in reacting a polyisocyanate with an active-hydrogen containing compound to form the urethane polymer or prepolymer is a polycarbonate.

Useful polyhydroxy polyacetals include the compounds that can be prepared from the reaction of (A) aldehydes, such as formaldehyde and the like, and (B) glycols such as diethylene glycol, triethylene glycol, ethoxylated 4,4′-dihydroxydiphenyldimethylmethane, 1,6-hexanediol, and the like. Polyacetals can also be prepared by the polymerization of cyclic acetals.

Instead of or in addition to a polyol, other compounds may also be used to prepare the prepolymer. Examples include polyamines, polyester amides and polyamides, such as the predominantly linear condensates obtained from reaction of (A) polybasic saturated and unsaturated carboxylic acids or their anhydrides, and (B) polyvalent saturated or unsaturated aminoalcohols, diamines, polyamines, and the like, and mixtures thereof.

Diamines and polyamines are among the preferred compounds useful in preparing the aforesaid polyester amides and polyamides. Suitable diamines and polyamines include 1,2-diaminoethane, 1,6-diaminohexane, 2-methyl-1,5-pentanediamine, 2,2,4-trimethyl-1,6-hexanediamine, 1,12-diaminododecane, 2-aminoethanol, 2-[(2-aminoethyl)amino]-ethanol, piperazine, 2,5-dimethylpiperazine, 1-amino-3-aminomethyl-3,5,5-trimethyl-cyclohexane (isophorone diamine or IPDA), bis-(4-aminocyclohexyl)methane, bis-(4-amino-3-methyl-cyclohexyl)-methane, 1,4-diaminocyclohexane, 1,2-propylenediamine, hydrazine, urea, amino acid hydrazides, hydrazides of semicarbazido-carboxylic acids, bis-hydrazides and bis-semicarbazides, diethylene triamine, triethylene tetramine, tetraethylene pentamine, pentaethylene hexamine, N,N,N-tris-(2-aminoethyl)amine, N-(2-piperazinoethyl)-ethylene diamine, N,N′-bis-(2-aminoethyl)-piperazine, N,N,N′-tris-(2-aminoethyl)ethylene diamine, N—[N-(2-aminoethyl)-2-amino-ethyl]-N′-(2-aminoethyl)-piperazine, N-(2-aminoethyl)-N′-(2-piperazinoethy-1)-ethylene diamine, N,N-bis-(2-aminoethyl)-N-(2-piperazinoethyl)amine, N,N-bis-(2-piperazinoethyl)-amine, polyethylene imines, iminobispropylamine, guanidine, melamine, N-(2-aminoethyl)-1,3-propane diamine, 3,3′-diaminobenzidine, 2,4,6-triaminopyrimidine, polyoxypropylene amines, tetrapropylenepentamine, tripropyl enetetramine, N,N-bis-(6-aminohexyl)amine, N,N′-bis-(3-aminopropyl)ethylene diamine, and 2,4-bis-(4′-aminobenzyl)-aniline, and the like, and mixtures thereof. Preferred diamines and polyamines include 1-amino-3-aminomethyl-3,5,5-tri-methyl-cyclohexane (isophorone diamine or IPDA), bis-(4-aminocyclohexyl)-m-ethane, bis-(4-amino-3-methyl cyclohexyl)-methane, ethylene diamine, diethylene triamine, triethylene tetramine, tetraethylene pentamine, and pentaethylene hexamine, and the like, and mixtures thereof. Other suitable diamines and polyamines include Jeffamine™. D-2000 and D-4000, which are amine-terminated polypropylene glycols, differing only by molecular weight, and which are available from Huntsman Chemical Company.

Another way to describe polyurethanes relates to weight percentage of hard and soft segments in the polyurethane. The hard segments in the polyurethane are typically characterized as the isocyanate component, and any low molecular weight (<500 Daltons) polyol chain extenders, diamines and polyamines (generally in the same molecular weight range), and the hydroxycarboxylic acids used as water dispersibility enhancing components. The soft segments are the polymeric polyols of at least 500 Daltons (number average molecular weight). In one embodiment, the amount of soft segments is desirable from about 30 to about 85 wt. % of the polyurethane (with the components forming the hard segment being the complimentary amount), more desirably from about 35 to about 75 wt. % of the polyurethane, and preferably from about 40 to about 65 or 72 wt. % of the polyurethane (with the components forming the hard segments being the complimentary amount).

Water-Dispersibility Enhancing Compounds

Polyurethanes are generally hydrophobic (oleophilic) and not water-dispersible. In accordance with one embodiment, therefore, at least one water-dispersibility enhancing compound (i.e., monomer), which has at least one, hydrophilic, ionic or potentially ionic group is optionally included in the polyurethane prepolymer to assist dispersion of the polyurethane prepolymer as well as the chain-extended polyurethane made therefrom in water, thereby enhancing the stability of the dispersions so made. Typically, this is done by incorporating a compound bearing at least one hydrophilic group or a group that can be made hydrophilic (e.g., by chemical modifications such as neutralization) into the polymer chain. These compounds may be of a nonionic, anionic, cationic or zwitterionic nature or the combination thereof. For example, anionic groups such as carboxylic acid groups can be incorporated into the prepolymer in an inactive form and subsequently activated by a salt-forming compound, such as a tertiary amine defined more fully hereinafter, in order to create a prepolymer having an acid number from about 1 to about 60, typically 1 or 5 to about 40, or 7 or 10 to 35, 12 to 30, or 14 to 25. Other water-dispersibility enhancing compounds can also be reacted into the prepolymer backbone through urethane linkages or urea linkages, including lateral or terminal hydrophilic ethylene oxide or ureido units.

Water dispersibility enhancing compounds of particular interest are those which can incorporate carboxyl groups into the prepolymer. Normally, they are derived from hydroxy-carboxylic acids having the general formula (HO)ₓQ(COOH)_{y}, wherein Q is a straight or branched hydrocarbon radical containing 1 to 12 carbon atoms, and x and y are 1 to 3. Examples of such hydroxy-carboxylic acids include dimethylolpropanoic acid (DMPA), dimethylol butanoic acid (DMBA), citric acid, tartaric acid, glycolic acid, lactic acid, malic acid, dihydroxymalic acid, dihydroxytartaric acid, and the like, and mixtures thereof. Dihydroxy-carboxylic acids are more preferred with dimethylolpropanoic acid (DMPA) being most preferred.

Another group of water-dispersibility enhancing compounds of particular interest are side chain hydrophilic monomers. Some examples include alkylene oxide polymers and copolymers in which the alkylene oxide groups have from 2-10 carbon atoms (preferably having 2 carbon atoms per repeat unit) as shown, for example, in U.S. Pat. No. 6,897,281, the disclosure of which is incorporated herein by reference.

Other suitable water-dispersibility enhancing compounds include thioglycolic acid, 2,6-dihydroxybenzoic acid, sulfoisophthalic acid, polyethylene glycol, and the like, and mixtures thereof. Compounds Having at Least One Crosslinkable Functional Group

Compounds having at least one crosslinkable functional group can also be incorporated into the polyurethane prepolymers, if desired. Examples of such compounds include those having carboxylic, carbonyl, amine, hydroxyl, epoxy, acetoacetoxy, olefinic and hydrazide groups, blocked isocyanates, and the like, and mixtures of such groups and the same groups in protected forms which can be reversed back into the original groups from which they were derived.

Other suitable compounds providing crosslinkability include thioglycolic acid, 2,6-dihydroxybenzoic acid, and the like, and mixtures thereof.

Catalysts

The prepolymer may be formed without the use of a catalyst if desired but may be preferred in some instances. Examples of suitable catalysts include stannous octoate, dibutyl tin dilaurate, and tertiary amine compounds such as triethylamine and bis(dimethylaminoethyl) ether, morpholine compounds such as beta,beta-dimorpholinodiethyl ether, bismuth carboxylates, zinc bismuth carboxylates, iron (III) chloride, potassium octoate, potassium acetate, and DABCO® (diazabicyclo[2.2.2]octane), from Air Products. The preferred catalyst is a mixture of 2-ethylhexanoic acid and stannous octoate, e.g., FASCAT®. 2003 from Elf Atochem North America.

Ingredient Proportions

Normally, the prepolymer produced will be isocyanate-terminated. For this purpose, the ratio of isocyanate groups to active hydrogen groups in the prepolymer typically ranges from about 1.3/1 to about 2.5/1, preferably from about 1.5/1 to about 2.1/1, and more preferably from about 1.7/1 to about 2/1. This results in an isocyanate terminated prepolymer of limited molecular weight (due to the stoicheometry of active groups deviating from 1:1).

The typical amount of water-dispersibility enhancing compound chemically incorporated into the prepolymer will be up to about 50 wt. %, more typically from about 2 wt. %) to about 30 wt. %>, and more especially from about 2 wt. %> to about 10 wt. %> based on the total weight of the prepolymer. [0044] The amount of optional compounds having crosslinkable functional groups in the prepolymer will typically be up to about 1 milliequivalent, preferably from about 0.05 to about 0.5 milliequivalent, and more preferably from about 0.1 to about 0.3 milliequivalent per gram of final polyurethane on a dry weight basis.

The amount of catalyst used to form the prepolymer will typically be from about 5 to about 200 parts per million of the total weight of prepolymer reactants.

In this patent application, the term “consisting essentially of” when describing the polyurethane or polyurethane dispersion will mean the polyisocyanate component, the active-hydrogen containing species (which will include the poly(glycol adipate) and the hydroxy-carboxylic acid that functions to create dispersibility in water for the prepolymer or polyurethane, an optional chain extender for the prepolymer, and an optional prepolymer neutralizing agent. “Consisting essentially of shall exclude agents in amounts that materially affect the nature and performance of the polyurethane such as amounts of aromatic isocyanates that might affect the aliphatic isocyanate type polyurethane, active-hydrogen containing species in amount that will affect the nature of the urethane associated with the poly(glycol adipate), other dispersibility enhancing components in amounts that affect dispersibility such as nonionic or cationic dispersants, etc.

Prepolymer Manufacture

Aqueous dispersions of polyurethane composite particles are made by forming the polyurethane prepolymer in the substantial absence of water and then dispersing this blend in an aqueous medium. This can be done in any fashion so long as a continuous mass of the prepolymer (as opposed to discrete particles of the prepolymer) is formed in the substantial absence of water before the prepolymer is combined with water. Typically, prepolymer formation will be done by bulk or solution polymerization of the ingredients for the prepolymer.

Bulk and solution polymerization are well known techniques and are described, for example, in “Bulk Polymerization,” Vol. 2, pp 500-514, and “Solution Polymerization,” Vol. 15, pp 402-418, Encyclopedia of Polymer Science and Engineering, © 1989, John Wiley & Sons, New York. See, also, “Initiators,” Vol. 13, pp. 355-373, KirkOthmer, Encyclopedia of Chemical Technology, © 1981, John Wiley & Sons, New York. The disclosures of these documents are also incorporated herein by reference.

In those instances in which the prepolymer includes water-dispersibility enhancing compounds (chemically bound into the prepolymer) which produce pendant carboxyl groups, these carboxyl groups can be converted to carboxylate anions for enhancing the water-dispersibility of the prepolymer.

Suitable neutralizing agents for this purpose include tertiary amines, metal hydroxides, ammonium hydroxide, phosphines, and other agents well known to those skilled in the art. Tertiary amines and ammonium hydroxide are preferred, such as triethyl amine (TEA), dimethyl ethanolamine (DMEA), N-methyl morpholine, and the like, and mixtures thereof. Neutralizing agents differ from chain extension agent by their function and the nature of association with the prepolymer. It is recognized that primary or secondary amines may be used in place of tertiary amines, if they are sufficiently hindered to avoid interfering with the chain extension process.

### Chain Extension

The aqueous prepolymer particle dispersions produced as described above can be used as is, if desired. Alternatively, they can be chain extended to convert the prepolymers in the particles to more complex (higher molecular weight) polyurethanes.

As a chain extender, at least one of water, inorganic or organic polyamines having an average of about 2 or more primary and/or secondary amine groups, polyalcohols, ureas, or combinations thereof are suitable for use.

Suitable organic amines for use as a chain extender include diethylene triamine (DETA), ethylene diamine (EDA), meta-xylylenediamine (MXDA), aminoethyl ethanolamine (AEEA), 2-methyl pentane diamine, and the like, and mixtures thereof. Also suitable for practice are propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, sulfonated primary and/or secondary amines, and the like, and mixtures thereof. Suitable inorganic amines include hydrazine, substituted hydrazines, and hydrazine reaction products, and the like, and mixtures thereof. Suitable polyalcohols include those having from 2 to 12 carbon atoms, preferably from 2 to 8 carbon atoms, such as ethylene glycol, diethylene glycol, neopentyl glycol, butanediols, hexanediol, and the like, and mixtures thereof. Suitable ureas include urea and it derivatives, and the like, and mixtures thereof. Hydrazine is preferred and is most preferably used as a solution in water. The amount of chain extender typically ranges from about 0.5 to about 1.1 equivalents based on available isocyanate.

Additional Ingredients and Features

The polyurethane prepolymers, the product polyurethanes produced therefrom, and the aqueous urethane dispersions as described above can be made with various additional ingredients and features in accordance with known polyurethane technology.

Polymer Branching

Branching of the ultimate polymer product, as well as the prepolymer, can be accomplished for the purpose of enhancing tensile strength and improving resistance to creep—that is, recovery to that of or near its original length after stretching. In this regard, see U.S. Pat. No. 6,897,281, the disclosure of which has been incorporated herein by reference above.

Monofunctional Active Hydrogen-Containing Compounds

The prepolymers can also be made with monofunctional active hydrogen-containing compounds to enhance dispersibility of the prepolymer in an aqueous medium and impart other useful properties, for example, cross-linkability, as well as to adjust the morphology and rheology of the polymer when coated onto a substrate, as also described in the above-noted U.S. Pat. No. 6,897,281.

Plasticizers

The polyurethane prepolymers and ultimate polyurethane products can be prepared in the presence of a plasticizer. The plasticizer can be added at any time during prepolymer preparation or dispersion or to the polyurethane during or after its manufacture. Plasticizers well known to the art can be selected for use according to parameters such as compatibility with the particular polyurethane and desired properties of the final composition. See, for example, WO 02/08327 A1, as well as the above-noted U.S. Pat. No. 6,897,281.

In some instances it is preferred to employ the polyurethane prepolymer dispersant with a graphene oxide, and particularly, with a graphene oxide having carbon to oxygen molar ratios of between about 2:1 and 25:1, or 1.5:1 and 20:1, or 1.25:1 and 15:1 or 1:1 and 5:1 or 10:1.

A further polyurethane dispersant that may be employed includes polyurethane polymers comprising from 35 to 90% by weight of poly (C₂₋₄-alkylene oxide) based on the total weight of the polyurethane polymer wherein not less than 60% by weight of the poly (C₂₋₄-alkylene oxide) is poly (ethylene oxide) and wherein at least 5% by weight of the poly (C₂₋₄-alkylene oxide) based on the weight of the polyurethane polymer is incorporated in lateral chains and which contains from 10 to 180 milliequivalents of acid groups for each 100 gms polyurethane when the polyurethane polymer contains from 35 to 45% by weight poly(alkylene oxide).

When the polyurethane polymer contains not less than 45% by weight of poly (alkylene oxide) it is also preferred that it contains from 10 to 180 milliequivalents of acid groups for each 100 gm polyurethane polymer.

Preferably at least 10%, more preferably at least 20% and especially at least 30% of the poly (C₂₋₄-alkylene oxide) based on the weight of the polyurethane polymer is incorporated in lateral chains.

It is also preferable that the acid groups in the polyurethane polymers are carboxylic acid groups.

The polyurethane polymer essentially comprises a linear backbone containing lateral poly (alkylene oxide) chains and optionally carboxylic acid groups. The polyurethane chains may also optionally carry terminal poly (C₂₋₄-alkylene oxide) chains. The polyurethane backbone is more hydrophobic in character than the lateral poly (alkylene oxide) chains. Without being bound to any specific mechanism involving the dispersion of particulate solids such as pigments in aqueous media it is thought that the relatively hydrophobic backbone of the polyurethane polymer interacts with the surface of the particulate solid and that the lateral poly (alkylene oxide) chains stabilise the coated particulate solid in the aqueous medium.

Whereas some degree of branching of the polyurethane backbone may be tolerated such branching should not lead to cross-linked matrices which impair the ability of the polyurethane polymer to disperse the particulate solid throughout the aqueous medium.

Preferably, the amount of poly (C₂₋₄-alkylene oxide) is not less than 40% and especially not less than 50% based on the total weight of the polyurethane polymer. It is also preferred that the amount of poly (C₂₋₄-alkylene oxide) is not greater than 80% and especially not greater than 70% based on the total weight of the polyurethane polymer.

The amount of poly (ethylene oxide) in the poly (C₂₋₄-alkylene oxide) which is located in the lateral and terminal chains, if present, of the polyurethane polymer is preferably not less than 70% and especially not less than 80% of the poly (C₂₋₄-alkylene oxide).

When the poly (alkylene oxide) chains contain repeat units other than ethyleneoxy, these may be propyleneoxy or butyleneoxy which may be arranged in random or block sequences.

Preferably the polyurethane polymer is unbranched.

The number average molecular weight of the poly (alkylene oxide) chains which are laterally or terminally attached to the polyurethane backbone is preferably not greater than 5,000, more preferably not greater than 3,000 and especially not greater than 2,500. The molecular weight of the poly (alkylene oxide) chain is also preferably not less than 350 and especially not less than 600. Good dispersants have been obtained where the number average molecular weight of the poly (alkylene oxide) chain is in the range of 350 to 2,500.

The amount of acid groups in the polyurethane polymer is preferably not greater than 110, more preferably not greater than 75 and especially not greater than 60 milliequivalents for each 100 gm of the polyurethane polymer. It is also preferred that the amount of carboxylic acid groups is not less than 20 milliequivalents for each 100 gm of polyurethane polymer. The acid groups may be present as the free acid or in the form of a salt. Preferably the salt is that of an alkali metal cation such as potassium, lithium or sodium, ammonia, amine or quaternary ammonium cation, including mixtures thereof. Examples of suitable amines are ethanolamine, diethanolamine and triethylamine. Examples of suitable quaternary ammonium salts are the C₁₋₈ alkyl quaternary ammonium salts. It is preferred that the acid is present as the salt of ammonia or other volatile amine.

The polyurethane polymers are obtainable by reacting together:
a) one or more poly isocyanates having an average functionality of from 2.0 to 2.5;
b) one or more compounds having at least one poly (C₂₋₄-alkylene oxide) chain and at least two groups which react with isocyanates which are located at the one end of the compound such that the poly (C₂₋₄-alkylene oxide) chain(s) is laterally disposed in relation to the polyurethane polymer backbone;
c) optionally, one or more compounds having at least one acid group and at least two groups which react with isocyanates;
d) optionally, one of more formative compounds having a number average molecular weight of from 32 to 3,000 which have at least two groups which react with isocyanates;
e) optionally, one or more compounds which act as chain terminators which contain one group which reacts with isocyanate groups.
f) optionally, one or more compounds which act as chain terminators which contain a single isocyanate group.

Preferably component (c) is a compound having one acid group.

As noted hereinbefore the polyurethane polymers according to the invention are essentially linear in character with respect to the polymer backbone. It is therefore preferred that the isocyanate which is component (a) has an average functionality of from 2.0 to 2.1. Examples of isocyanates are diisocyanates such as toluene diisocyanate (TDI), isophorone diisocyanate (IPDI), hexanediisocyanate (HDI), a, a′-tetramethylxylene diisocyanate (TMXDI), diphenylmethane-4,4′-diisocyanate (MDI) and dicyclohexylmethane-4,4′-diisocyanate (HMDI). Preferred diisocyanates are TDI, IPDI and HMDI.

The compound having a poly (alkylene oxide) chain which is component (b) preferably contains two groups which react with isocyanates. There are a number of ways of incorporating a poly (alkylene oxide) lateral chain into an organic compound which contains these groups which react with isocyanates.

Thus, in the case where the two groups which react with isocyanates are both hydroxyl, the poly (C₂₋₄-alkylene oxide) chain may be conveniently attached by isocyanates having a functionality of two or more. Compounds of this type are described in U.S. Pat. No. 4,794,147 which involves sequentially reacting a monofunctional polyether with a polyisocyanate to produce a partially capped isocyanate intermediate and reacting the intermediate with a compound having at least one active amino hydrogen and at least two active hydroxyl groups.

One preferred class of compound of this type may be presented by the formula 1.

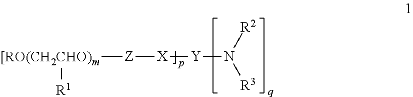

wherein
R is C₁₋₂₀-hydrocarbyl;
R¹ is hydrogen, methyl or ethyl of which not less than 60% is hydrogen;
R² and R³ are each, independently, C₁₋₈-hydroxyalkyl;
Z is C₂₋₄-alkylene;
X is —O— or —NH—;
Y is the residue of a polyisocyanate;
m is from 5 to 150;
p is from 1 to 4; and
q is 1 or 2.
R may be alkyl, aralkyl, cycloalkyl or aryl.
When R is aralkyl, it is preferably benzyl or 2-phenylethyl.
When R is cycloalkyl it is preferably C₃₋₈-cycloalkyl such as cyclohexyl.
When R is aryl it is preferably naphthyl or phenyl.
When R is alkyl, it may be linear or branched and preferably contains not greater than 12, more preferably not greater than 8 and especially not greater than 4 carbon atoms. It is especially preferred that R is methyl.

The C₂₋₄-alkylene radical represented by Z may be ethylene, trimethylene, 1,2-propylene or butylene.

Preferably m is not less than 10. It is also preferred that m is not greater than 100 and especially not greater than 80.

When q is 2 it is possible to link two different polyurethane polymer chains but it is much preferred that q is 1.

When the polyisocyanate has a functionality which is greater than 2, the compound which is component (b) may carry more than one poly (alkylene oxide) chain. However, it is much preferred that p is 1, q is 1 and that Y is the residue of a diisocyanate.

When R¹ is hydrogen and Z is ethylene and X is ˜O— the compound of formula 1 is a derivative of a mono-functional polyether such as polyethylene glycol monoalkyl ether.

When R¹ is hydrogen or a mixture of hydrogen and methyl and Z is 1,2-propylene and X is —NH— the compound of formula 1 is a derivative of polyalkylene glycol amine such as a Jeffamine M polyether available from Huntsman Corporation.

Preferably, R³ and R⁴ are both 2-hydroxyethyl.

It is also preferred that X is O.

Compounds of formula 1 are typically prepared by reacting a monofunctional polyether with a polyisocyanate in an inert solvent such as toluene at a temperature of from 50 to 100° C. and preferably in the presence of an acid catalyst until the derived isocyanate value is reached. The temperature is then normally reduced to between 40 and 60° C. when the requisite secondary amine such as diethanolamine is added.

Useful compounds of formula 1 have been used as component (b) by reacting a poly (ethylene glycol) mono methyl ether or a Jeffamine M series polyether having a number average molecular weight of from 250 to 5,000 with a diisocyanate such as TDI followed by diethanolamine.

A second preferred type of compound which can be used as component (b) is of formula 2.

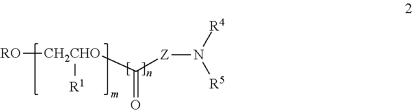

wherein
R, R¹, Z and m are as defined hereinbefore;
R⁴ is an isocyanate reactive organic radical;
R⁵ is hydrogen or an isocyanate-reactive organic radical; and
n is 0 or 1.

Compounds of formula 2 are disclosed in EP 317258.

The organic radical represented by R⁴ and R⁵ is an organic radical containing an isocyanate-reactive group, such as —OH, —SH, —COOH, —PO₃H₂ and —NHR⁶ in which R⁶ is hydrogen or optionally substituted alkyl. As specific examples of isocyanate-reactive radicals, there may be mentioned hydroxyalkyl, hydrox alkoxy alkyl, hydroxy (poly alkylene oxy) alkyl and hydroxy alkoxy carbonyl alkyl.

A preferred type of compound of formula 2 is where n is zero, Z is 1,2-propylene, R⁴ is 2-hydroxyethyl and R⁵ is hydrogen. Compounds of this type are obtainable by the Michaels addition reaction of a poly (alkylene oxide) monoalkyl ether monoamine and a hydroxy functional acrylate such as 2-hydroxyethyl acrylate or hydroxypropyl acrylate. A suitable source of poly (alkylene oxide) monoalkyl ether monoamine is the Jeffamine M series of polyethers available from Huntsman Corporation. The reaction between the poly (alkylene oxide) mono alkylether monoamine and 2-hydroxy functional acrylate is typically carried out in the presence of air and at a temperature of 50 to 100° C., optionally in the presence of a polymerisation inhibitor such as hydroquinone or butylated hydroxy toluene.

Another preferred type of compound of formula 2 is where n is zero, Z is 1,2-propylene and R⁴ and R⁵ are both 2-hydroxyethyl. Compounds of this type may be prepared by reacting a poly(alkylene oxide) mono alkyl ether mono amine with ethylene oxide under acidic conditions.

Yet another preferred type of compound of formula 2 is where n is zero, Z is 1,2-propylene and R⁴ is 2-hydroxyethyl and R⁵ is hydrogen. Compounds of this type may be prepared by reacting a poly(alkylene oxide) mono alkyl ether mono amine with about one stoichiometric equivalent of ethylene oxide under acidic conditions.

A third preferred type of compound which may be used as component (b) is of formula 3

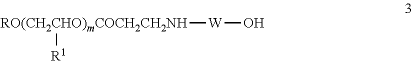

wherein R, 10 and m are as defined hereinbefore and W is C₂₋₆-alkylene and especially ethylene. Compounds of this type are obtainable by the Michael addition reaction of a hydroxy amine and a poly (alkylene oxide) acrylate.

A fourth preferred type of compound which may be used as component (b) is of formula 4.

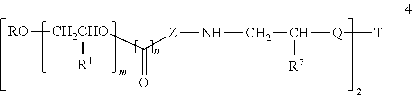

wherein
R, Z, m and n are as defined hereinbefore;
R⁷ represents hydrogen, halogen or C₁₋₄ alkyl;
Q is a divalent electron withdrawing group; and
T is a divalent hydrocarbon radical which may carry substituents or contain hetero atoms.

Examples of electron withdrawing groups which may be represented by Q include —CO—, —COO—, —SO—, —SO₂—, —SO₂O— and —CONR⁸— in which R⁸ is hydrogen or alkyl.

Hydrocarbon radicals which may be represented by T include alkylene, arylene and mixtures thereof, said radicals optionally carrying substituents or containing hetero-atoms. Examples of suitable radicals represented by T are alkylene radicals containing from 1 to 12 carbon atoms, oxyalkylene and polyoxyalkylene radicals of the formula —(CH₂CHR¹O)ₓ wherein R¹ is as defined hereinbefore and x is from 1 to 10, phenylene and diphenylene radicals and other arylene radicals such as

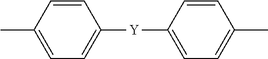

wherein Y is —O—, —S—, —CH₂—, —CO— or —SO₂—

The compounds of Formula 4 are obtainable by the Michael addition reaction of two moles of a poly (alkylene oxide) monoalkyl ether monoamine with one mole of an unsaturated compound of the formula 5.

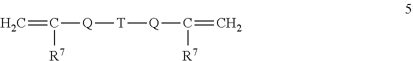

wherein Q, T and IC are as defined hereinbefore.

Examples of unsaturated compounds of Formula 5 are especially diacrylates and dimethacrylates wherein T is a C₄₋₁₀-alkylene residue, a polyoxyalkylene residue or an oxyethylated Bisphenol A residue.

A fifth preferred type of compound which may be used as component (b) is a compound of formula 6.

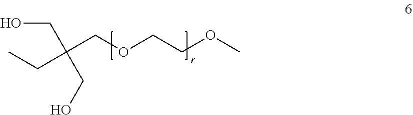

wherein
r is from 4 to 100.
   Preferably, r is not less than 10 and especially not less than 15. It is also preferred that r is not greater than 80, more preferably not greater than 60 and especially not greater than 40.

A specific example is Tegomer D 3403 (p is approximately 20) ex Tego Chemie.

As disclosed hereinbefore, the acid compound which is component (c) of the polyurethane polymer is preferably a carboxylic acid. It is also preferred that component (c) is a diol and is especially a compound of formula 7.

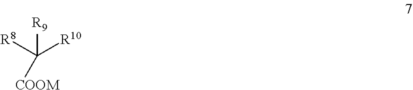

wherein at least two of the groups R⁸, R⁹ and 10° are C₁₋₆-hydroxy alkyl and the remainder is C₁₋₆-hydrocarbyl, which may be linear or branched alkyl, aryl, aralkyl or cycloalkyl, M is hydrogen or an alkaline metal cation, or quaternary ammonium cation. Preferred examples of carboxylic acid components are dimethylolpropionic acid (DMPA) and dimethylolbutyric acid (DMBA).

The acid containing compound which is component (c) may contain other acid groups in addition to or instead of a carboxylic group(s), such as phosphonic or sulphonic acid groups. Examples of such compounds are 1,3-benzene dicarboxylic acid-5-sulpho-1,3-bis (2-hydroxyethyl) ester (EGSSIPA) and a compound of formula

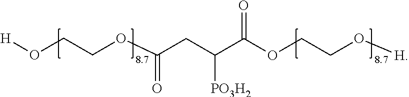

The formative compounds which are component (d) of the polyurethane are preferably difunctional in respect of reactivity with isocyanates although a small amount of higher functionality may be used where a small amount of branching of the polyurethane polymer backbone is desired. However, it is preferred that component (d) is difunctional. Preferred reactive groups are amino and hydroxy and it is much preferred that component (d) is a diamine or especially a diol. Component (d), if present, is used primarily as a chain extender to alter the hydrophilic/hydrophobic balance of the polyurethane polymer. It is much preferred that the polyurethane backbone is more hydrophobic than the lateral side chains and terminal side chains (when present). Component (d) optionally contains other amine moieties such as aliphatic tertiary amine, aromatic amine or cyclo aliphatic amine groups, including mixtures thereof.

Examples of suitable diamines are ethylene diamine, 1,4-butane diamine and 1,6-hexane diamine.

Examples of suitable diols are 1,6-hexanediol, 1,4-cyclohexanedimethanol (CHDM), 1,2-dodecane diol, 2-phenyl-1,2-propanediol, 1,4-benzene dimethanol, 1,4-butanediol and neopentyl glycol. The diol may also be a polyether such as a poly (C₂₋₄-alkylene glycol). The polyalkylene glycol may be a random or block (co)polymer containing repeat ethyleneoxy, propyleneoxy or butyleneoxy groups, including mixtures thereof. As noted hereinbefore, it is preferred that the polyurethane backbone is more hydrophobic than the lateral or terminal chains (when present). Consequently, in the case of copolymers involving ethylene oxide repeat units in component (d) it is preferred that the amount of ethylene oxide in component d is not greater than 40%, more preferably not greater than 20% and especially not greater than 10% by weight of the copolymer. It is particularly preferred that polyalkylene glycol is free fromethyleneoxide repeat units.

As noted hereinbefore, it is preferred that the polyurethane polymer backbone is essentially linear in character. However, some small amount of branching may be tolerated and this branching may conveniently be introduced by means of a higher functional polyol such as timethylol propane, trimethylolethane or pentaerythritol.

As disclosed hereinbefore the chain terminating compound which is component (e) is mono-functional with respect to the isocyanate. The monofunctional group is preferably an amino or hydroxy group. Preferred terminating groups are poly (C₂₋₄-alkylene) mono alkyl ethers and mono alkyl ether amines similar to those used in the preparation of the lateral side chain compounds which are component (b) of the polyurethane.

An example of a monoisocyanate which acts as a chain terminating compound (component f) is phenyl Isocyanate.

It is much preferred that the amount of component (f) is zero.

Typical amounts of the aforementioned compounds from which the polyurethane polymers are obtainable are 15-50% component (a), 10-80% component (b), 0-24% component (c), 0-25% component (d), 0-50% component (e) and 0-20% component (f), all based on the total weight of the polyurethane polymer.

When component (e) is a monofunctional polyether, the total amount of component (b) with component (e) is preferably not less than 35% and where component (e) is other than a monofunctional polyether the amount of component (b) is preferably not less than 35%.

The polyurethane polymers according to the invention may be prepared by any method known to the art. Typically, the polyurethane polymer is obtainable by reacting one or more isocyanates having a functionality of from 2.0 to 2.5 (component (a)) with one or more compounds having a poly (C₂₋₄-alkylene oxide) chain and at least two groups which react with isocyanates which are located at one end (component (b)) under substantially anhydrous conditions and in an inert atmosphere at a temperature between 30 and 130° C., optionally in the presence of an inert solvent and optionally in the presence of a catalyst. Optionally, the reaction may also be carried out in the presence of one or more compounds having at least one acid group (component (c)) and one or more formative compounds acting as chain extenders (component (d)) and optionally one or more compounds which act as chain terminating compounds which are components (e) and (f).

The inert atmosphere may be provided by any of the inert gases of the Periodic Table but is preferably nitrogen.

The preparation of the polyurethane polymer/prepolymer may be carried out in the presence of a catalyst. Particularly preferred catalysts are tin complexes of aliphatic acids such as dibutyl tin dilaurate (DBTDL) and tertiary amines.

The essential feature of the polyurethane polymer according to the invention is that it comprises a predominantly linear polyurethane polymer backbone containing the defined amount of lateral poly (alkylene oxide) side chains. There will thus be many variants which will be obvious to the skilled addressee regarding the ratio of isocyanate groups to isocyanate reactive groups including the formulation of prepolymers which have residual isocyanate functionality. In one case, the ratio of total isocyanate groups provided by component (a) is less than the total number of isocyanate reactive groups provided by component (b) and components (c) (d) and (e) when present. Any terminal isocyanate reactive groups may be reacted.

Alternatively, the ratio of total number of isocyanate groups provided by component (a) and optionally component (f) is greater that the total number of isocyanate reactive groups provided by component (b) and components (c), (d) and (e) when present. The resultant polyurethane is then a prepolymer containing residual isocyanate functionality. This prepolymer may then be reacted with other chain extenders such as component (d) which conjoin different prepolymer chains and/or with chain terminating compounds which are component (e) either prior to or during dissolution in water or other polar solvent.

The preparation of prepolymers can be useful since it is a means of controlling viscosity during the preparation of the polyurethane polymer, especially in circumstances where the reaction is carried out in the absence of any solvent.

When a prepolymer is formed which contains isocyanate functionality, chain extension may be carried out by water itself, or a polyol, amino-alcohol, a primary or secondary aliphatic, alicyclic, aromatic, araliphatic or heterocyclic polyamine especially a diamine, hydrazine or a substituted hydrazine. Water-soluble chain extenders are preferred.

Examples of suitable chain extenders include ethylenediamine, diethylene triamine, triethylene tetramine, propylenediamine, butylenediamine, hexamethylenediamine, cyclohexylenediamine, piperazine, 2-methyl piperazine, phenylenediamine, tolylene diamine, xylylene diamine, tris (2-aminoethy)amine, 3,3′-dinitrobenzidine, 4,4′methylenebis (2-chloraniline), 3,3′-dichloro-4,4′bi-phenyl diamine, 2,6-diaminopyridine, 4,4′-diaminodiphenylmethane, methane diamine, m-xylene diamine, isophorone diamine, and adducts of diethylene triamine with acrylate or its hydrolyzed products. Also materials such as hydrazine, azines such as acetone azine, substituted hydrazines such as, for example, dimethyl hydrazine, 1,6-hexamethylenebis-hydrazine, carbodihydreazine, hydrazides of dicarboxylic acids and sulphonic acid such as adipic acid mono- or dihydrazide, xalic acid dihydrazide, isophthalic acid dihydrazide, tartaric acid dihydrazide, 1,3-phenylene disulphonic acid dihydrazide, omega-aminocaproic acid dihydrazide, hydrazides made by reacting lactones with hydrazide such as gamma-hydroxylbutyric hydrazide, bis-semi-carbazide carbonic esters of glycols such as any of the glycols mentioned above.

Where the chain extender is other than water, for example, a diamine or hydrazine, it may be added to an aqueous dispersion of prepolymer or, alternatively, it may already be present in an aqueous medium other than that in which the prepolymer is dispersed/dissolved.

The chain extension can be conducted at elevated, reduced or ambient temperatures. Convenient temperatures are from about 5° C. to 95° C.

When employing a prepolymer in the preparation of the polyurethane polymer, the amount of chain extender and chain terminating compound are chosen to control the molecular weight of the polyurethane polymer. A high molecular weight will be favored when the number of isocyanate-reactive groups in the chain extender is approximately equivalent to the number of free isocyanate groups in the prepolymer. A lower molecular weight of the polyurethane polymer is favored by using a combination of chain extender and chain terminator in the reaction with the polyurethane prepolymer.

An inert solvent may be added before, during or after formation of the polyurethane polymer/prepolymer in order to control viscocity. Examples of suitable solvents are acetone, methylethylketone, dimethylformamide, dimethylacetamide, diglyme, N-methylprrolidone, ethylacetate, ethylene and propylene glycoldiacetates, alkyl ethers of ethylene and propylene glycol acetates, toluene, xylene and sterically hindered alcohols such as t-butanol and diacetone alcohol. Preferred solvents are acetone, methyl ethylketone and N-methylpyrrolidone.

The number average molecular weight of the polyurethane polymer is preferably not less than 2,000, more preferably not less than 3,000 and especially not less than 4,000. It is also preferred that the number average molecular weight of the polyurethane polymer is not greater than 50,000, more preferably not greater than 20,000 and especially not greater than 15,000.

Another class of dispersants that provides improved graphene platelet production water-dispersible or soluble dihydrocarbyl dithiophosphoric acids or salts having the formula II

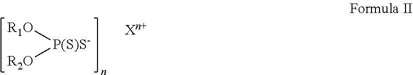

wherein R₁ and R₂ are different hydrocarbyl groups containing up to about 18 carbon atoms, n is an integer equal to the valence of X, and Xⁿ⁺ is a dissociating cation.

The hydrocarbyl groups R₁ and R₂ may be different aliphatic, different aromatic, and/or mixtures of aliphatic and aromatic groups containing up to about 18 carbon atoms. More generally, the alkyl groups will contain from about 2 to about 12 carbon atoms, and the aryl groups will contain from about 6 to about 18 carbon atoms. Thus, in one embodiment, R₁ and R₂ are different aliphatic groups; in a second embodiment, R₁ and R₂ are different aromatic groups, and in a third embodiment, R₁ may be an aliphatic group and R₂ an aromatic group. As noted, Xⁿ⁺ may be any dissociating cation, and in one embodiment X is hydrogen, an ammonium group, an alkali metal or an alkaline earth metal. Water-soluble collectors generally are preferred, and thus, X normally is an ammonium group, an alkali metal or certain Group II metals. The alkali metals, sodium and potassium are particularly preferred but can also include lithium, magnesium, calcium, ammonium or mixtures thereof.

The dihydrocarbyldithiophosphoric acids and salts represented by Formula II are known compounds and may be prepared by the reaction of a mixture of hydroxy-containing organic compounds such as alcohols and phenols with a phosphorus sulfide such as P2S5. The dithiophosphoric acids generally are prepared by reacting from about 3 to 5 moles, more generally 4 moles of the hydroxy-containing organic compound (alcohol or phenol) with one mole of phosphorus pentasulfide in an inert atmosphere at temperatures from about 50° C. to about 150° C. with the evolution of hydrogen sulfide. The reaction normally is completed in about 1 to 3 hours. The salts of the phosphorodithioic acids can be prepared also by techniques well known to those in the art including the reaction of the dithiophosphoric acid with ammonia, and various derivatives of alkali and Group II metals such as the oxides, hydroxides, etc. The formation of the salt typically is carried out in the presence of a diluent (e.g., alcohol, water, or diluent oil).

The composition of the phosphorodithioic acid obtained by the reaction of a mixture of hydroxy-containing organic compounds with phosphorus pentasulfide is actually a statistical mixture of phosphorodithioic acids wherein, with reference to Formula II derived from a mixture of two hydroxy compounds, R₁OH and R₂OH, R₁ and R₂ in one of the acids are different hydrocarbyl groups derived from the different alcohols, R₁ and R₂ in a second phosphorodithioic acid are identical and derived from one of the alcohols, and R₁ and R₂ in a third phosphorodithioic acid are identical but derived from the second alcohol of the alcohol mixture.

Monohydroxy organic compounds useful in the preparation of the dihydrocarbylphosphorodithioic acids and salts useful in the present invention include alcohols, phenol and alkyl phenols including their substituted derivatives, e.g., nitro-, halo-, alkoxy, hydroxy-, carboxy-, etc. Suitable alcohols include, for example, ethanol, n-propanol, isopropanol, n-butanol, 2-butanol, 2-methyl-propanol, n-pentanol, 2-pentanol, 3-pentanol, 2-methylbutanol, 3-methyl-2-pentanol, n-hex-anol, 2-hexanol, 3-hexanol, 4-methyl-2-pentanol, 2-methyl-3-pentanol, cyclohexanol, chlorocylohexanol, methylcyclohexanol, heptanol, 2-ethylhexanol, n-octanol, nononanol, dodecanol, etc. Phenols suitable for the dihydrocarbylphosphorodithioic acids include alkyl phenols and substituted phenols such as phenol, chlorophenol, bromophenol, nitrophenol, methoxyphenol, cresol, naphthol, propylphenol, heptylphenol, octylphenol, decyl phenol, dodecyl phenol, 1-naphthol, 2-naphthol and commercially available mixtures of phenols. The aliphatic alcohols containing from about 4 to 6 carbon atoms are particularly useful in preparing the dihydrocarbylphosphorodithioic acids and salts, etc.

Typical mixtures of alcohols and phenols which can be used in the preparation of dihydrocarbylphosphorodithioic acids and salts of Formula II include: isobutyl and n-amyl alcohols; sec-butyl and n-amyl alcohols; propyl and n-hexyl alcohols; isobutyl alcohol, n-amyl alcohol and 2-methyl-1-butanol; phenol and n-amyl alcohol; phenol and cresol, etc. In one embodiment, the alcohol can be 2-methyl-propanol to give a compound where R₁ and R₂ are both methyl-propyl groups. In embodiment, the alcohol can be cresol to give a compound where R₁ and R₂ are both cresol groups.

Several dihydrocarbylphosphorodithioic acids and salts are exemplified in the following examples.

Dihydrocarbylphosphorodithioic Acids and Salts Synthesis Example 1

To 804 parts of a mixture of 6.5 moles of isobutyl alcohol and 3.5 moles of mixed primary amyl alcohols (65% w n-amyl and 35% w 2-methyl-1-butanol) is prepared, and there are added 555 parts (2.5 moles) of phosphorus pentasulfide while maintaining the reaction temperature between about 104-107° C. After all of the phosphorus pentasulfide is added, the mixture is heated for an additional period to insure completion of the reaction and filtered. The filtrate is the desired phosphorodithioic acid which contains about 11.2% phosphorus and 22.0% sulfur.

Dihydrocarbylphosphorodithioic Acids and Salts Synthesis Example 2

The general procedure of Example 1 is repeated at 90° C. except that the alcohol mixture reacted with phosphorus pentasulfide comprises 40 mole percent of isopropyl alcohol and 60 mole percent of 4-methyl-s-amyl alcohol. The phosphorodithioic acid prepared in this manner contains about 10.6% of phosphorus.

Dihydrocarbylphosphorodithioic Acids and Salts Synthesis Example 3

A mixture of 246 parts (2 equivalents) of Cresylic Acid 33 (a mixture of mono-, di- and tri-substituted alkyl phenols containing from 1 to 3 carbon atoms in the alkyl group commercially available from Merichem Company of Houston, Tex.), 260 parts (2 equivalents) of isooctyl alcohol and 14 parts of caprolactam is heated to 55° C. under a nitrogen atmosphere. Phosphorus pentasulfide (222 parts, 2 equivalents) is added in portions over a period of one hour while maintaining the temperature at about 78° C. The mixture is maintained at this temperature for an additional hour until completion of the phosphorus pentasulfide addition and then cooled to room temperature. The reaction mixture is filtered through a filter aid, and the filtrate is the desired phosphorodithioic acid.

Dihydrocarbylphosphorodithioic Acids and Salts Synthesis Example 4

A mixture of 2945 parts (24 equivalents) of Cresylic Acid 57 (Merichem) and 1152 parts (6 equivalents) of heptylphenol is heated to 105° C. under a nitrogen atmosphere whereupon 1665 parts (15 equivalents) of phosphorus pentasulfide are added in portions over a period of 3 hours while maintaining the temperature of the mixture between about 115-120° C. The mixture is maintained at this temperature for an additional 1.5 hours upon completion of addition of the phosphorus pentasulfide and then cooled to room temperature. The reaction mixture is filtered through a filter aid, and the filtrate is the desired phosphorodithioic acid.

Dihydrocarbylphosphorodithioic Acids and Salts Synthesis Example 5

A mixture of 400 parts of 50% aqueous sodium hydroxide (5.7 equivalents) and 1137 parts of water is prepared, and a mixture of 90 parts (1.1 equivalents) of a 60/40 mixture of isobutyl alcohol/primary amyl alcohol mixture and 1424 parts (5 equivalents) of the phosphorodithioic acid of Example 1 is added dropwise while maintaining the reaction temperature at about 40-45° C. over a period of 4 hours. After the addition is completed, the mixture is stirred for 45 minutes, and an additional 56 parts of the 50% aqueous sodium hydroxide solution are added with stirring. The color of the mixture changes from dark green to yellow, and 287 parts of water is added with stirring. The mixture, after cooling, is filtered through a filter aid, and the filtrate is the desired sodium salt containing 10.5% sulfur (theory, 9.43) and 3.52% sodium (theory, 3.86).

Dihydrocarbylphosphorodithioic Acids and Salts Synthesis Example 6

A mixture of 176 parts of a 50% aqueous solution of sodium hydroxide, 189 parts of the alcohol mixture of Example 1 and 40 parts of water is prepared, and 581.4 parts of the phosphorodithioic acid of Example 1 are added over a period of 2 hours while maintaining the temperature of the mixture at less than 50° C. After the addition is completed, the mixture is maintained at 50-55° C. for 2 hours and filtered. The filtrate is the desired product containing 12.95% sulfur (theory, 12.98).

Dihydrocarbylphosphorodithioic Acids and Salts Synthesis Example 7

A mixture of 448 parts of zinc oxide (11 equivalents) and 467 parts of the alcohol mixture of Example 1 is prepared, and 3030 parts (10.5 equivalents) of the phosphorodithioic acid of Example 1 are added at a rate to maintain the reaction temperature at about 45-50° C. The addition is completed in 3.5 hours whereupon the temperature of the mixture is raised to 75° C. for 45 minutes. After cooling to about 50° C., an additional 61 parts of zinc oxide (1.5 equivalents) are added, and this mixture is heated to 75° C. for 2.5 hours. After cooling to ambient temperature, the mixture is stripped to 124° C. at 12 mm. pressure. The residue is filtered twice through a filter aid, and the filtrate is the desired zinc salt containing 22.2% sulfur (theory, 22.0), 10.4% phosphorus (theory, 10.6) and 10.6% zinc (theory, 11.1).

Dihydrocarbylphosphorodithioic Acids and Salts Synthesis Example 8

A mixture of 160 parts of a 50% aqueous solution of sodium hydroxide, 40 parts of water and 200 parts of the alcohol mixture of Example 5 is prepared, and 626 parts of the phosphorodithioic acid of Example 2 are added dropwise over a period of 1.5 hours. The reaction is exothermic to 55° C., and after all of the phosphorodithioic acid is added, the temperature of the reaction mixture is increased to 65° C. and maintained at this temperature for 2 hours. An additional 9 parts of the 50% aqueous sodium hydroxide solution are added, and the mixture is maintained for an additional 2 hours at 55-65° C. The mixture is filtered through a filter aid, and the filtrate is the desired product as a 25% solution in the alcohol mixture. The product contains 12.92% sulfur (theory, 12.37).

Dihydrocarbylphosphorodithioic Acids and Salts Synthesis Example 9

A mixture of 146 parts (2.5 equivalents) of ammonium hydroxide and 40 parts of water is prepared. Beginning at room temperature, there is added 581.4 parts (2 equivalents) of the phosphorodithioic acid prepared in Example 1 over a period of 2.5 hours. The reaction is exothermic to 40° C., and after all of the phosphorodithioic acid is added, the reaction mixture is maintained at 50° C. for 2 hours. An additional 59.4 parts (0.2 equivalents) of the phosphorodithioic acid are added and the mixture is maintained at about 50° C. for 15 hours, cooled and filtered. The filtrate is the desired ammonium salt which is a clear liquid.

Dihydrocarbylphosphorodithioic Acids and Salts Synthesis Example 10

To 129 parts of ammonium hydroxide (2.3 equivalents) there is added 644.4 parts (2.0 equivalents) of the phosphorodithioic acid prepared in Example 2 over a period of 2 hours. The reaction is exothermic to 40° C. After stirring for 2 hours at this temperature, the mixture is cooled and 5 parts of ammonium hydroxide are added through a sub-surface inlet tube. The mixture is stirred at 40° C. for one hour whereupon 78 parts of the isobutylamyl alcohol mixture described in Example 1 are added. The mixture is filtered through a filter aid, and the filtrate is the desired ammonium salt containing 15.84% sulfur (theory, 14.95).

Dihydrocarbylphosphorodithioic Acids and Salts Synthesis Example 11

A mixture of 63 parts (1.55 equivalents) of zinc oxide, 144 parts of mineral oil and one part of acetic acid is prepared. A vacuum is applied and 533 parts (1.3 equivalents) of the phosphorodithioic acid prepared in Example 3 are added while heating the mixture to about 80° C. The temperature is maintained at 80-85° C. for about 7 hours after the addition of the phosphorodithioic acid is complete. The residue is filtered, and the filtrate is the desired product containing 6.8% phosphorus.

Dihydrocarbylphosphorodithioic Acids and Salts Synthesis Example 12

A mixture of 541 parts (13.3 equivalents) of zinc oxide, 14.4 parts (0.24 equivalent) of acetic acid and 1228 parts of mineral oil is prepared, and a vacuum is applied while raising the temperature to about 70° C. The phosphorodithioic acid prepared in Example 4 (4512 parts, 12 equivalents) is added over a period of about 5 hours while maintaining the temperature at 68-72° C. Water is removed as it forms in the reaction, and the temperature is maintained at 68-72° C. for 2 hours after the addition of phosphorodithioic acid is complete. To insure complete removal of water, vacuum is adjusted to about 10 mm., and the temperature is raised to about 105° C. and maintained for 2 hours. The residue is filtered, and the filtrate is the desired product containing 6.26% phosphorus (theory, 6.09) and 6.86% zinc (theory, 6.38).

Dihydrocarbylphosphorodithioic Acids and Salts Synthesis Example 13

A mixture of 78.7 parts (1.1 equivalents) of cuprous oxide and 112 parts of mineral oil is prepared, and 384 parts (1 equivalent) of the phosphorodithioic acid prepared as in Example 4 are added over a period of 2 hours while raising the temperature gradually to about 55° C. Upon completion of the addition of the acid, the reaction mixture is maintained at about 50° C. for about 3 hours. A vacuum then is applied while raising the temperature to about 80° C. The residue is filtered, and the filtrate is the desired cuprous salt which is a clear liquid containing 12% sulfur (theory, 11.5) and 12.0% copper (theory, 11.4).

In some instances it is preferred to employ the water-dispersible or soluble dihydrocarbyl dithiophosphoric acid or salt dispersants with a graphene oxide, and particularly, with a graphene oxide having carbon to oxygen molar ratios of between about 2:1 and 25:1, or 1.5:1 and 20:1, or 1.25:1 and 15:1 or 1:1 and 5:1 or 10:1.

The dispersant can be a cationic or ampholytic polymer.

Suitable cationic polymers can be synthetically derived, or natural polymers can be synthetically modified to contain cationic moieties. Several cationic polymers their manufacturers and general descriptions of their chemical characteristics are found in the CTFA Dictionary and in the International Cosmetic Ingredient Dictionary, Vol. 1 and 2, 5th Ed., published by the Cosmetic Toiletry and Fragrance Association, Inc. (CTFA) (1993), the pertinent disclosures of which are incorporated herein by reference.

In one aspect, the cationic polymer can be selected from the group consisting of cationic or amphoteric polysaccharides, polyethyleneimine and its derivatives, a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N, N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride, methacryloyloxyethyl trimethyl ammonium methylsulfate, and combinations thereof. The cationic polymer may optionally comprise a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS® monomer) and their salts. The polymer may be a terpolymer prepared from more than two monomers. The polymer may optionally be branched or cross-linked by using branching and crosslinking monomers. Branching and crosslinking monomers include ethylene glycoldiacrylate divinylbenzene, and butadiene. In one aspect, the cationic polymer may include those produced by polymerization of ethylenically unsaturated monomers using a suitable initiator or catalyst, such as those disclosed in WO 00/56849 and U.S. Pat. No. 6,642,200. In one aspect, the cationic polymer may comprise charge neutralizing anions such that the overall polymer is neutral under ambient conditions. Suitable counter ions include (in addition to anionic species generated during use) include chloride, bromide, sulfate, methylsulfate, sulfonate, methylsulfonate, carbonate, bicarbonate, formate, acetate, citrate, nitrate, and mixtures thereof.

In one aspect, the cationic polymer can be selected from the group consisting of poly(acrylamide-co-diallyldimethylammonium chloride), poly(acrylamide-co-methacryloyloxyethyl trimethylammonium methylsulfate) poly(acrylamide-co-methacryl amidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethyl ammonium chloride-co-acrylic acid), poly(acrylamide-co-methacrylamidopropyltrimethyl ammonium chloride-co-acrylic acid), poly(diallyldimethyl ammonium chloride), poly(methylacrylate-co-methacrylamidopropyltrimethyl ammonium chloride-co-acrylic acid), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethyl ammonium chloride-co-acrylic acid), poly(vinyl pyrrolidone-co-quaternized vinyl imidazole), poly(acrylamide-co-methacrylamidopropyl-pentamethyl-1,3-propylene-2-ol-ammonium dichloride), and copolymer of 1,3-dibromopropane and N,N-diethyl-N′,N′-dimethyl-1,3-diaminopropane.

The foregoing cationic polymers may be further classified by their INCI (International Nomenclature of Cosmetic Ingredients) names as Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32, Polyquaternium-33, Polyquaternium-34, Polyquaternium-39, Polyquaternium-47 and Polyquaternium-53.

The cationic polymer may include natural polysaccharides that have been cationically and/or amphoterically modified. Representative cationically or amphoterically modified polysaccharides include those selected from the group consisting of cationic and amphoteric cellulose ethers; cationic or amphoteric galactomannans, such as cationic guar gum, cationic locust bean gum and cationic cassia gum; chitosan; cationic and amphoteric starch; and combinations thereof. These polymers may be further classified by their INCI names as Polyquarternium-10, Polyquaternium-24, Polyquaternium-29, Guar Hydroxypropyltrimonium Chloride, Cassia Hydroxypropyltrimonium Chloride and Starch Hydroxypropyltrimonium Chloride.

Suitable cationic polymers are commercially available under the Merquat™ tradename, product designations 100, 106, 550, 550L, 550PR, S, 7SPR, 740, 2220, CG600, 280, 280SD, 281, 280NP, 295, PLUS 3330, PLUS 3331, 3330PR, 3331PR, 3330DRY, 3940, 2001, 2001N, 2003PR marketed by Lubrizol Advanced Materials, Inc., Cleveland, Ohio.

In an embodiment, the dispersant can be a quaternary homopolymers or copolymers derived from dimethyl diallyl ammonium salts having an average molecular weight between 75,000 and 500,000. In an embodiment, the dispersant can be a copolymer of dimethyl diallyl ammonium salts formed from dimethyl diallyl ammonium chloride and an acrylamide. In an embodiment, the dispersant can be a copolymer of dimethyl diallyl ammonium salt and acrylic acid having a weight average molecular weight of between 1,000,000 and 1,500,000, as determined by gel permeation chromatography. In an embodiment, the dispersant can be a methacrylamide alkyl quaternary ammonium salt acrylic acid-acrylamide copolymer. In an embodiment, the dispersant can be a copolymer of acrylic acid, acrylamide, and methacrylamidopropyltrimethylammonium chloride. In an embodiment, the dispersant can be a copolymer of methacrylamidopropyltrimethylammonium chloride, dimethyl diallyl ammonium salt, an acrylic acid.

While the foregoing dispersants play a significant role in controlling the properties of the graphene platelet, the reaction time of the process can also play a role. For example, the number of layers of the graphene platelet may be affected by the time and parameters used in the exfoliation process. The reaction time may be controlled in conjunction with the dispersants to achieve desired layering and particle size of the graphene platelets produced. In one embodiment, the reaction time for a single cycle is 60 minutes, or in some embodiments the single cycle can be 120 minutes. More than one cycle may be carried out.

The initial concentration of the graphene platelet can also play a role in obtaining optimal dispersed graphene nano-platelet concentrations. In some embodiments, the original concentration of graphene nano-platelet may be from 0.1 to 5 g per 100 g of solution, or from 0.25 to 2.5 g per 100 g of solution, or even from 0.5 or 0.75 to 2 g per 100 g of solution, or from 1.25 to 1.75 g per 100 g of solution. The foregoing method can prepare a composition of graphene platelets, a dispersant, and aqueous or polar solvent.

The graphene platelets produced from the exfoliation method described above may be separated using any suitable method. Examples include decanting, centrifugation and filtration (e.g. membrane filtration). To separate the graphene platelets, a portion of the mixture may be removed from the process, for example, after a particular reaction time. In one embodiment, the sample may be continuously withdrawn from the process, for example, via a holding tank.

Following separation, the graphene platelets produced from the method may be dried using any suitable method. An example of a suitable drying method is vacuum drying.

The graphene platelets produced may have an average particle size of 100 nm or less, preferably 80 nm or less, more preferably 60 nm or less, for example, 20 nm or less. By particle size, it is meant the thickness of the graphene platelet particles rather than diameter. In one embodiment, the particle size (thickness) is 0.4 to 15 nm, preferably 0.4 to 10 nm, for example, 0.4 to 5 nm or 0.4 to 10 nm. The diameter of the particles may range from 5 to 50 microns, for example, 5 to 25 or 10 microns. In one embodiment, the graphene platelets produced have an average particle size (thickness) of 0.4 to 5 nm and a diameter of 5 to 10 microns. In another embodiment, the graphene platelets produced have an average particle size (thickness) of 0.4 to 10 nm and a diameter of 5 to 15 microns.

Particle size may be measured using any known method. For example, an electron dual beam microscopy or scanning probe microscopy may be used. Raman spectroscopy, X-ray diffraction or an atomic force microscope may also be used to measure the particle size. The resulting thickness of the graphene platelets is determined by treatment time and type of solvent.

In one embodiment, a prevalence (up to 98%) of the particles have an average particle size (thickness) of 0.4 to 5 nm. In one embodiment, the effective particle diameter is 5 to 50 microns.

The graphene platelets produced or obtainable using the method described may be used for a wide range of applications. For example, the graphene platelets may be used as an additive for polymers, such as polyethylene and polystyrene. The graphene platelets may also be used for electrical or electronic applications, such as an electrode additive for, for example, lithium accumulators, or in the manufacture of supercapacitors. The graphene platelets may also be formulated into inks and coatings to achieve desired thermal and electrical properties.

Graphene platelets obtained using the described method may also be used in a thermal interface material, such as a thermal grease. The thermal conductivity of the thermal grease may be in the range of up to 300 Wm‘V’¹.

The method may allow graphene platelets to be produced in high yield in a relatively time and cost-efficient process.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, byproducts, derivatives, and other such materials which are normally understood to be present in the commercial grade.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:
hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);
substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);
hetero substituents, that is, substituents which, while having a predominantly hydrocarbon character, in the context of this invention, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

Additionally, as used herein, the term “substantially” means that a value of a given quantity is within ±10% of the stated value. In other embodiments, the value is within ±5% of the stated value. In other embodiments, the value is within ±2.5% of the stated value. In other embodiments, the value is within ±1% of the stated value.

The invention herein is useful for preparing exfoliated graphene platelets, which may be better understood with reference to the following examples.

### Examples

### Exfoliation by Ultrasonication

From 0.1 to 0.85 wt % of the noted dispersant was dissolved in deionized (“DI”) water, or appropriate organic solvent. 2.5 g Angstrom Materials N006-P graphene nanoplatelet solids purchased from Global Graphene Group were added to 500 g of the dispersant solution. The mixtures were then sonicated using an ultrasonic probe (1200 W max power, 20 kHz frequency). The amplitude of the ultrasonication probe was set between 25-75% maximum. The sonication time for dispersion varied between 1 to 8 hours. After sonication, 75 mL of the dispersed graphene solution is placed in a 100 mL centrifuge tube and centrifuged in a SX4750 Beckman Coulter centrifuge rotor at 3000 rpm (avg RCF 640, max RCF 931) for 30 min. The top 75% of the centrifuged sample was used for concentration analysis by UV-Vis. For the higher concentration dispersions, UV-Vis samples were diluted with appropriate solvent prior to collecting spectra. Graphene concentrations were estimated using the UV absorption spectra with the estimated molar absorption coefficient of 2460 mL/mg/L @ 660 nm as reported in the literature.

Table 1 summarizes the solvent/dispersant systems and exfoliation/dispersion conditions that were used, and the final concentrations achieved.

TABLE 1
Graphene dispersion conditions

| | | | | Conc. |
|---|---|---|---|---|
| | Conc. | | | dispersed |
| | Disp. | % | Duration | GNP |
| Dispersant | (% wt) | Amp | (h) | (mg/mL) |
| sodium dodecylsulfate | 0.1 | 75 | 2 | 0.22 |
| Na Maleic anhydride Styrene | 0.1 | 75 | 2 | 0.04 |
| Copolymer | | | | |
| butyl beta-(hydroxyethyl) ester | 0.1 | 75 | 2 | 0.04 |
| Polyurethane prepolymer | 0.1 | 75 | 2 | 0.09 |
| Na-dicresol dithiophosphates | 0.1 | 75 | 2 | 0.19 |
| Na-naphthol dithiophosphates | 0.1 | 75 | 2 | 0.28 |
| carboxyl containing | 0.1 | 75 | 2 | 0.27 |
| interpolymer | | | | |
| derivatized polycarboxylate | 0.1 | 75 | 2 | 0.28 |
| 35-90 wt % Alkylene oxide | 0.1 | 75 | 2 | 0.30 |
| Polyurethane polymer | | | | |
| dodecyl beta-(hydroxyamino) | 0.1 | 75 | 2 | 0.20 |
| ester | | | | |
| Imide polymer | 0.1 | 75 | 2 | 0.29 |
| Imide polymer | 0.1 | 75 | 8 | 0.31 |
| Imide polymer | 0.55 | 75 | 2 | 0.32 |
| Imide polymer | 0.85 | 75 | 2 | 0.37 |
| Imide polymer | 0.25 | 75 | 2 | 0.42 |
| Polymer of dimethyl diallyl | 0.1 | 75 | 2 | 0.12 |
| ammonium salt | | | | |
| Polymer of dimethyl diallyl | 0.1 | 75 | 2 | 0.88 |
| ammonium salt and | | | | |
| acrylamide | | | | |
| Copolymer of dimethyl diallyl | 0.1 | 75 | 2 | 1.16 |
| ammonium salt and acrylic | | | | |
| acid | | | | |
| Copolymer of copolymer of | 0.1 | 75 | 2 | 0.65 |
| acrylic acid, acrylamide, and | | | | |
| methacrylamidopropyltri- | | | | |
| methylammonium chloride | | | | |

It was noted that ultrasonic probe dispersion was more effective than bath sonication, and longer probe sonication times lead to slightly higher dispersion concentrations.

The effect of graphene platelet concentration was also tested according to the table below.

| | Dispersant | % | duration | Dispersed |
|---|---|---|---|---|
| GNP Loading Ratio | (% wt) | Amp | (h) | GNP (mg/mL) |
| 0.5 g GNP/100 g H2O | 0.1* | 75 | 2 | 0.29 |
| 1.0 g GNP/100 g H2O | 0.1* | 75 | 2 | 0.49 |
| 1.5 g GNP/100 g H2O | 0.1* | 75 | 2 | 1.09 |
| 1.5 g GNP/100 g H2O | 0.1** | 75 | 2 | 1.11 |
| 2.0 g GNP/100 g H2O | 0.1* | 75 | 2 | 0.01 |

*imide containing polymer
**carboxyl containing interpolymer

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or openended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

A composition comprising
1) a graphene platelet
2) a dispersant selected from at least one of
   i. carboxyl containing interpolymers
   ii. derivatized polycarboxylate dispersant
   iii. imide polymers comprising a polymer chain having at least one fused aromatic imide pendant group, wherein the polymer is represented by formula (1):

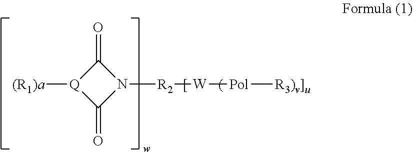

wherein each variable is independently
R₁ is a substituent on Q ring in any position available for bonding to a substituent group and R₁ is independently represented by at least one electron withdrawing group;
a is 1 or 2, or 1;
W is oxygen, sulphur, >NH, or >NG;
R₂ is a C₁ to C₂₀, or C₁ to C₁₂, or C₁ to C₆ hydrocarbylene group;
R₃ is H or C₁₋₅₀ (or C₁₋₂₀)-optionally substituted hydrocarbyl group that bonds to a terminal oxygen atom of the polymer chain forming a terminal ether or terminal ester group and may or may not contain a group capable of polymerization such as a vinyl group, or C₁₋₅₀ (or C₁₋₂₀)-hydrocarbonyl group (i.e., a hydrocarbyl group containing a carbonyl group) that bonds to the oxygen atom of the polymer chain forming a terminal ester group or terminal urethane group and may or may not contain a group capable of polymerization such as a vinyl group, and the substituent is halo, ether, ester, or mixtures thereof;
Pol is a homopolymer chain of ethylene oxide or a copolymer chain of ethylene oxide, wherein the ethylene oxide constitutes 40 wt % to 99.99 wt % of the copolymer chain and where in the polymer chain is selected from the group consisting a poly(ether), poly(ester) and mixtures thereof;
u=1 to 3;
v=1 to 2;
w=1 to 3
v=2 when W=>NG;
v=1 when W=Oxygen, Sulphur, or >NG;
G is a hydrocarbyl group containing 1 to 200, or 1 to 100, or 1 to 30 carbon atoms; and
Q is a fused aromatic ring containing 4n+2 π-electrons, wherein n=2 or more, and Q is bonded to the imide group in such a way to form a 5 or 6 membered imide ring
iv. cycloaliphatic polyurethane resins wherein said polyurethane resin is derived from reacting a polyisocyanate comprising a diisocyanate of formula

O═C═N—R—N═C═O
with an active-hydrogen containing compound to form a urethane polymer or prepolymer,
wherein at least 60% by weight of the polyisocyanate resin component is characterized as a cycloaliphatic isocyanate because the R group includes only aliphatic moieties of 4 to 30 carbon atoms; and
wherein said active-hydrogen containing compound comprises a poly(glycol adipate);
v. alkylene oxide polyurethane polymers comprising from 35% to 90% by weight of a poly (C₂₋₄-alkylene oxide) based on the total weight of the polyurethane polymer wherein not less than 60% by weight of the total poly (C₂₋₄-alkylene oxide) is poly (ethylene oxide) and wherein at least 5% poly (C₂₋₄-alkylene oxide) based on the total weight of the polyurethane polymer is incorporated in lateral chains, which lateral chains are characterized as poly(C₂₋₄-alkylene oxide) chains with at least two groups, which react with isocyanates, which are located at the one end of the chain such that said chains are laterally disposed in relation to the polyurethane polymer backbone, wherein said polyurethane polymer has a number average molecular weight of not less than 2,000 and not greater than 50,000 g/mole and which polyurethane polymer contains from 10 to 180 milli-equivalents of acid groups for each 100 gm polyurethane when the polyurethane polymer contains from 35 to 45% by weight poly (alkylene oxide);
vi. water-dispersible or soluble dihydrocarbyl dithiophosphoric acid or salt having the formula II

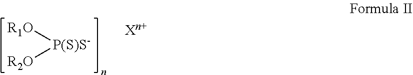

wherein R₁ and R₂ are hydrocarbyl groups containing up to about 18 carbon atoms, n is an integer equal to the valence of X, and Xⁿ⁺ is a dissociating cation, and
3) at least one aqueous or polar solvent.

The composition of the preceding paragraph, wherein the graphene platelets is in the form of at least one of: mono-layer graphene; multi-layer graphene (2-10 layers); graphite nano-platelets (>10 layers).

The composition of any preceding paragraph, wherein the dispersant consists essentially of, or consists of the at least one carboxyl containing interpolymer.

The composition of any preceding paragraph, wherein the carboxyl containing interpolymer comprises at least one olefinically unsaturated carboxylic acid or anhydride containing at least one activated carbon-to-carbon olefinic double bond and at least one carboxyl group, in an amount of more than 15% by weight based upon the weight of the interpolymer

The composition of any preceding paragraph, wherein said carboxy containing interpolymer is a block copolymer of 12-hydroxystearic acid.

The composition of any preceding paragraph, wherein said polymer of 12-hydroxystearic acid is a block copolymer with polyethylene oxide.

The composition of any preceding paragraph, wherein said polymer of 12-hydroxystearic acid is an ABA block copolymer.

The composition of any preceding paragraph, wherein the carboxylic acid of the carboxy containing polymer, has an olefinic double bond in the alpha-beta position with respect to a carboxyl group, or is part of a terminal methylene group.

The composition of any preceding paragraph, wherein the carboxylic acid of the carboxy containing interpolymer is selected from the group consisting of acrylic acid, methacrylic acid, and maleic acid.

The composition of any preceding paragraph, wherein said carboxylic acid of the carboxy containing interpolymer is an anhydride

The composition of any preceding paragraph, wherein said anhydride is maleic anhydride.

The composition of any preceding paragraph, wherein the carboxylic acid or anhydride of the carboxy containing interpolymer is present in amounts greater than 40 weight percent based upon the weight of the interpolymer.

The composition of any preceding paragraph, wherein at least one olefinically unsaturated monomer containing at least one CH₂═C< group is copolymerized with the carboxy containing interpolymer.

The composition of any preceding paragraph, wherein the olefinically unsaturated monomer is an acrylamide or substituted acrylamide.

The composition of any preceding paragraph, wherein at least one C₁-C₅ alkyl vinyl ether is polymerized with the carboxy containing interpolymer.

The composition of any preceding paragraph, wherein at least one C₂-C₃₀ alpha olefin is polymerized with the carboxy containing interpolymer.

The composition of any preceding paragraph, wherein there is present in the carboxy containing interpolymer less than 5 weight percent based upon the weight of the carboxylic acid or anhydride of a polyfunctional crosslinking vinylidene monomer containing at least two terminal CH₂< groups.

The composition of any preceding paragraph, wherein said crosslinking monomer is selected from the group consisting of allyl pentaerythritol, allyl sucrose and trimethylolpropane diallylether.

The composition of any preceding paragraph, wherein the carboxy containing interpolymer further includes at least one acrylic acid ester of the formula:

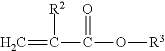

wherein R² is hydrogen, methyl or ethyl and R³ is an alkyl group containing 1 to 30 carbon atoms, in an amount of less than 30 weight percent based upon the weight of the carboxylic acid or anhydride plus the acrylic acid ester.

The composition of any preceding paragraph, wherein R² is hydrogen or methyl and R³ is an alkyl group containing 2 to 20 carbon atoms.

The composition of any preceding paragraph, comprising (1) at least one olefinically unsaturated carboxylic acid or anhydride containing at least one activated carbon-to-carbon olefinic double bond and at least one carboxyl group, in an amount of more than 15% by weight based upon the weight of the interpolymer, and (2) at least one steric stabilizer having at least one hydrophilic moiety and at least one hydrophobic moiety, selected from the group consisting of linear block copolymeric steric stabilizers, having a hydrophobic moiety having a length of more than 50 Angstroms, random copolymeric comb steric stabilizers, and mixtures thereof, having admixed therewith a wetting additive selected from the group consisting of a low surface tension surface active agent, a glycol, a polyhydric alcohol and mixtures thereof.

The composition of any preceding paragraph wherein said wetting additive is present in an amount of about 0.001% to about 10.0% by weight based upon the weight of the interpolymer.

The composition of any preceding paragraph wherein said wetting additive is present in an amount about 0.001% to about 5.0% by weight based upon the weight of the interpolymer.

The composition of any preceding paragraph wherein said wetting additive is present in an amount of about 0.001% to about 2.0% by weight based upon the weight of the interpolymer.

The composition of any preceding paragraph wherein said wetting additive is admixed with said interpolymer after said interpolymer is polymerized.

The composition of any preceding paragraph wherein said polyhydric alcohol is glycerine.

The composition of any preceding paragraph wherein said low surface tension surface active agent is selected from the group consisting of hydrocarbon, fluorocarbon and silicone surface active agents capable of reducing the surface tension of water to less than about 40 dynes per centimeter at 25° C.

The composition of any preceding paragraph wherein said low surface tension surface active agent is selected atom the group consisting of hydrocarbon, fluorocarbon and silicone surface active agents capable of reducing the surface tension of water to less than about 30 dynes per centimeter at 25° C.

The composition of any preceding paragraph wherein said steric stabilizer is present in an amount of 0.001 to 15% by weight based upon the weight of said carboxylic acid or said anhydride.

The composition of any preceding paragraph, wherein said linear block copolymeric steric stabilizer, it is defined by the following formula: C_{w}—(B-A-B_{y})ₓ-D_{z} wherein A is a hydrophilic moiety having a solubility in water at 25° C. of 1% or greater, a molecular weight of from about 200 to about 50,000, and selected to be covalently bonded to B; B is a hydrophobic moiety having a molecular weight of from about 300 to about 60,000, a solubility of less than 1% in water at 25° C., capable of being covalently bonded to A; C and D are terminating groups which can be A or B, can be the same or different groups, w is 0 or 1; x is an integer of 1 or more, y is 0 or 1, and z is 0 or 1.

The composition of any preceding paragraph, wherein said random copolymeric comb steric stabilizer, it is defined by the following formula: R₁—(Z)ₘ-(Q)ₙ-R₂ where R₁ and R₂ are terminating groups and may be the same or different and will be different from Z and Q, Z is a hydrophobic moiety having a solubility of less than 1% in water at 25° C., Q is a hydrophilic moiety, having a solubility of more than 1% in water at 25° C., and m and n are integers of 1 or more, and are selected such that the molecular weight is from about 100 to about 50,000.

The composition of any preceding paragraph wherein said block copolymer is a block copolymer of 12-hydroxystearic acid.

The composition of any preceding paragraph wherein said polymer of 12-hydroxystearic acid is a block copolymer with polyethylene oxide.

The composition of any preceding paragraph wherein said polymer of 12-hydroxystearic acid is an ABA block copolymer.

The composition of any preceding paragraph wherein in said carboxylic acid, said olefinic double bond is in the alpha-beta position with respect to a carboxyl group, or is part of a terminal methylene group.

The composition of any preceding paragraph wherein said carboxylic acid is selected from the group consisting of acrylic acid, methacrylic acid, and maleic acid.

The composition of any preceding paragraph wherein said anhydride is maleic anhydride.

The composition of any preceding paragraph wherein said carboxylic acid or anhydride is present in amounts greater than 40 weight percent based upon the weight of the interpolymer.

The composition of any preceding paragraph wherein at least one olefinically unsaturated monomer containing at least one CH₂═C<group is copolymerized therewith.

The composition of any preceding paragraph wherein said olefinically unsaturated monomer is an acrylamide or substituted acrylamide.

The composition of any preceding paragraph wherein at least one C₁-C₅ alkyl vinyl ether is polymerized therewith.

The composition of any preceding paragraph wherein at least one C₂-C₃₀ alpha olefin is polymerized therein.

The composition of any preceding paragraph wherein there is present less than 5 weight percent based upon the weight of the carboxylic acid or anhydride of a polyfunctional crosslinking vinylidene monomer containing at least two terminal CH₂<groups.

The composition of any preceding paragraph wherein said crosslinking monomer is selected from the group consisting of allyl pentaerythritol, allyl sucrose and trimethylolpropane diallylether.

The composition of any preceding paragraph further including at least one acrylic acid ester of the formula: CH₂═CR²—CO—OR³ wherein R² is hydrogen, methyl or ethyl and R³ is an alkyl group containing 1 to 30 carbon atoms, in an amount of less than 30 weight percent based upon the weight of the acrylic acid or anhydride plus the acrylic acid ester.

The composition of any preceding paragraph wherein R² is hydrogen or methyl and R³ is an alkyl group containing 2 to 20 carbon atoms.

The composition of any preceding paragraph wherein said comb steric stabilizer is a polymer of dimethicone copolyol phosphate.

The composition of any preceding paragraph, wherein the dispersant consists essentially of, or consists of the at least one derivatized polycarboxylate dispersant.

The composition of any preceding paragraph, wherein the derivatized polycarboxylate dispersant comprises a backbone having moieties derived from (a) an unsaturated hydrocarbon; (b) at least one of a substituted carboxylic acid monomer, a substituted ethylenically unsaturated monomer, and maleic anhydride, and (c) optionally including an N-polyoxyalkylene succinimide; and wherein derivative moieties are pendant to the backbone monomer by at least one ester linkage and at least one amide linkage.

The composition of any preceding paragraph, wherein the derivatized polycarboxylate dispersant is a random copolymer of general structural units shown below:

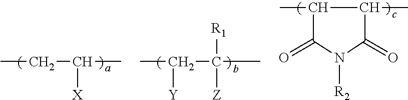

wherein:
the “b” structure is one of a substituted carboxylic acid monomer, a substituted ethylenically unsaturated monomer, and maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
X=H, CH₃, C₂ to C₆ Alkyl, Phenyl, or Substituted Phenyl;
Y=H, —COOM, —COOH, or W;
W=a hydrophobic defoamer represented by the formula R₅—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the derivatized polycarboxylate dispersant;
Z=H, —COOM, —OR₃, —COORS, —CH₂OR₃, or —CONHR₃;
R₁=H, or CH₃;
R₂, R₃, are each independently a random copolymer of oxyethylene units and oxypropylene units of the general formula (CH₂C(R₁)HO)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₈ alkyl or C₆ to C₁₈ alkyl aryl;
M=Alkali Metal, Alkaline Earth Metal, Ammonia, Amine, or Substituted Amine;
a=0.01-0.8;
b=0.2-0.99;
c=0-0.5; and
wherein a, b, c represent the mole fraction of each unit and the sum of a, b, and c, is 1.

The composition of any preceding paragraph, wherein a in the derivatized polycarboxylate dispersant is from 0.01 to 0.6.

The composition of any preceding paragraph, wherein a in the derivatized polycarboxylate dispersant is from 0.01 to 0.5.

The composition of any preceding paragraph, wherein b in the derivatized polycarboxylate is from 0.3 to 0.99.

The composition of any preceding paragraph, wherein b in the derivatized polycarboxylate dispersant is from 0.4 to 0.99.

The composition of any preceding paragraph, wherein c in the derivatized polycarboxylate dispersant is from 0 to 0.3.

The composition of any preceding paragraph, wherein c in the derivatized polycarboxylate dispersant is from 0 to 0.1.

The composition of any preceding paragraph, wherein the “a” structure in the derivatized polycarboxylate dispersant includes at least one of a styrene moiety and a sulfonated styrene.

The composition of any preceding paragraph, wherein X in the derivatized polycarboxylate dispersant is selected from the group consisting of p-Methyl Phenyl, p-Ethyl Phenyl, Carboxylated Phenyl and Sulfonated Phenyl.

The composition of any preceding paragraph, wherein M in the derivatized polycarboxylate dispersant is selected from the group consisting of monoethanol amine, diethanol amine, triethanol amine, morpholine and imidazole.

The composition of any preceding paragraph, wherein the dispersant consists essentially of, or consists of the at least one imide polymer.

The composition of any preceding paragraph, wherein the polymer chain of the imide polymer is a Poly(ether) of either (i) a polyethylene oxide homopolymer, or (ii) a copolymer of ethylene oxide with either propylene oxide, butylene oxide, styrene oxide or mixtures thereof.

The composition of any preceding paragraph, wherein the fused aromatic ring or fused aromatic di-acid or anhydride or other acid-forming derivative of the imide polymer is based on 1,8-naphthalene imide, or 1,2-naphthalene imide or mixtures thereof.

The composition of any preceding paragraph, wherein the polymer chain of the imide polymer is a poly(ether) polymer chain represented by Formula (3a):

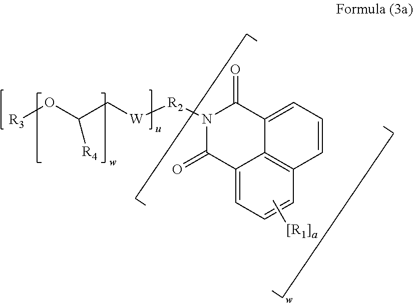

wherein each variable is independently
R₁ is a substituent on Q ring in any position available for bonding to a substituent group and R₁ is independently represented by at least one electron withdrawing group selected from —CN, —NO₂, —SO₂NR′₂, SO₃M, halo-NH₂, or —OR;
a is 1 or 2;
W is oxygen, sulphur, or >NG;
R′ is independently —H, or an optionally-substituted alkyl, typically, containing 1 to 20, or 1 to 10 carbon atoms, and the substituents is hydroxyl or halo (typically Cl), or mixtures thereof;
R₂ is a C₁ to C₂₀ hydrocarbylene group or a C₁ to C₂₀ hydrocarbonylene group when
R₂ contains more than 2 carbon atoms, the hydrocarbylene group or hydrocarbonylene group is linear or branched;
G is a hydrocarbyl group containing 1 to 200 carbon atoms;
R₃ is H or C₁₋₅₀-optionally substituted hydrocarbyl group that bonds to a terminal oxygen atom of the polymer chain forming a terminal ether or terminal ester group and may or may not contain a group capable of polymerization such as a vinyl group, or C₁₋₅₀-hydrocarbonyl group that bonds to the oxygen atom of the polymer chain forming a terminal ester group or terminal urethane group and may or may not contain a group capable of polymerization such as a vinyl group, and the substituent is halo, ether, ester, or mixtures thereof;
R₄ is H when Pol is a homopolymer, and R₄ is a mixture of H (in an amount sufficient to provide ethylene oxide groups at 40 wt % to 99.99 wt %) and at least one of methyl, ethyl and phenyl, when Pol is a copolymer;
u is 1 to 3;
w is 1 to 3; and
m is 1 to 110.

The composition of any preceding paragraph, wherein the electron withdrawing group of the imide polymer is —Cl or —NO₂ or —SO₃M, wherein M is H, a metal cation, —NR′₄⁺, or mixtures thereof.

The composition of any preceding paragraph, wherein the dispersant consists essentially of, or consists of the at least one polyurethane polymer.

The composition of any preceding paragraph, wherein the diisocyanate of formula O═C═N—R—N═C═O of the cycloaliphatic polyurethane resin is chosen from the group consisting of H12 MDI (substantially aliphatic and cyclic) and IPDI (substantially aliphatic and cyclic).

The composition of any preceding paragraph, wherein at least 85% of the diisocyanate of the cycloaliphatic polyurethane polymer is chosen from the group consisting of H12 MDI (substantially aliphatic and cyclic), IPDI (substantially aliphatic and cyclic), and mixtures thereof.

The composition of any preceding paragraph, wherein at least 85% of the diisocyanate of the cycloaliphatic polyurethane resin is chosen from the group consisting of H12 MDI (substantially aliphatic and cyclic).

The composition of any preceding paragraph, wherein the active-hydrogen containing compound of the cycloaliphatic polyurethane resin comprises a poly(glycol adipate) and said poly(glycol adipate) comprises the reaction of adipic acid with glycols selected from the group consisting of ethylene glycol, 1,2- and 1,3-propylene glycols, 1,2-, 1,3-, 1,4-, and 2,3-butylene glycols, hexane diols, neopentyl glycol, 1,6-hexanediol, and 1,8-octanediol.

The composition of any preceding paragraph, wherein the cycloaliphatic polyurethane resin is derived from an active hydrogen-containing compound comprising a polyester characterized as an adipate ester of 1,6-hexane diol and neopentyl glycol.

The composition of any preceding paragraph, wherein the polyester characterized as the adipate ester of 1,6-hexane diol and neopentyl glycol of the cycloaliphatic polyurethane resin is characterized by a number average molecular weight of 500 to 10,000 Daltons.

The composition of any preceding paragraph wherein the active hydrogen-containing compound of the cycloaliphatic polyurethane resin comprises a mixture of two or more active hydrogen containing compounds comprising the same polymer (backbone) type but having different molecular weights.

The composition of any preceding paragraph, wherein at least 75 mole % of the active hydrogen containing compound of the cycloaliphatic polyurethane resin used to form the urethane is a polyester from aliphatic linear and branched diols reacted with adipic acid.

The composition of any preceding paragraph, wherein at least 75 mole % of the active hydrogen containing compound of the cycloaliphatic polyurethane resin used to form the urethane is a polyester from 1,6-hexane diol and neopentyl glycol reacted with adipic acid.

The composition of any preceding paragraph, wherein at least 85 mole % of the active hydrogen containing compound of the cycloaliphatic polyurethane resin used to form the urethane is a polyester from aliphatic linear and branched diols reacted with adipic acid.

The composition of any preceding paragraph, wherein the cycloaliphatic polyurethane resin is derived from reacting a polyisocyanate comprising a diisocyanate of formula O═C═N—R—N═C═O with an active-hydrogen containing compound to form a urethane polymer or prepolymer, initially forms a prepolymer with an acid number from about 1 to about 40 (more desirably about 10 to about 35) mgKOH/g polymer.

The composition of any preceding paragraph, wherein the cycloaliphatic polyurethane resin is derived from reacting a polyisocyanate comprising a diisocyanate of formula O═C═N—R—N═C═O with an active-hydrogen containing compound and with a hydroxy-carboxylic acid having the general formula

(HO)ₓQ(COOH)y,

wherein Q is a straight or branched hydrocarbon radical containing 1 to 12 carbon atoms, and x and y are 1 to 3.

The composition of any preceding paragraph, wherein said cycloaliphatic polyurethane resin consists essentially of the reaction product from reacting a) said diisocyanate of formula O═C═N—R—N═C═O with b) said active-hydrogen containing compound, c) a hydroxy-carboxylic acid having the general formula (HO)ₓQ(COOH)_{y}, wherein Q is a straight or branched hydrocarbon radical containing 1 to 12 carbon atoms, and x and y are 1 to 3, optionally d) a chain extender, and optionally e) a prepolymer pH neutralizing agent.

The composition of any preceding paragraph, comprising an active ionic colloidal stabilizing moiety in the cycloaliphatic polyurethane resin selected from the group consisting of DMPA and DMBA.

The composition of any preceding paragraph, wherein the cycloaliphatic polyurethane resin is chain extended with a di-functional or higher amine with solubility in the continuous water phase of at least 20 grams per liter.

The composition of any preceding paragraph wherein said di-functional amine or higher amine is selected from the group consisting of: alkylene diamines; hydrazine; amino ethanol amines; and mixtures thereof.

The composition of any preceding paragraph, wherein the dispersant consists essentially of, or consists of the at least one alkylene oxide polyurethane polymer comprising from 35% to 90% by weight of a poly (C₂₋₄-alkylene oxide) based on the total weight of the polyurethane polymer.

The composition of any preceding paragraph, wherein poly (C₂₋₄-alkylene oxide) is located in lateral or terminal, if present chains and the amount of poly(ethylene oxide) is not less than 80% by weight of the poly (C₂₋₄-alkylene oxide) located in lateral or terminal, if present, chains.

The composition of any preceding paragraph, wherein the amount of poly (C₂₋₄-alkylene oxide) is not less than 50% and not greater than 70% based on the total weight of the polymer.

The composition of any preceding paragraph, wherein the alkylene oxide polyurethane further optionally comprising terminally attached poly(alkylene oxide) chains, wherein the number average molecular weight of the poly (alkylene oxide) chains which are attached laterally or terminally to the polyurethane backbone is from 350 to 2,500 g/mole.

The composition of any preceding paragraph, wherein the alkylene oxide polyurethane contains not less than 20 and not greater than 60 milliequivalents of acid groups for each 100 gm of the polyurethane polymer and wherein at least 10% by weight of the poly(alkylene oxide) is located in lateral chains.

The composition of any preceding paragraph, wherein the alkylene oxide polyurethane comprises from 35% to 90% by weight of a poly (C₂₋₄-alkylene oxide) based on the total weight of the polyurethane polymer wherein not less than 60% by weight of the total poly (C₂₋₄-alkylene oxide) is poly (ethylene oxide) and wherein at least 5% poly (C₂₋₄-alkylene oxide) based on the total weight of the polyurethane polymer is incorporated in lateral chains, which lateral chains are characterized as poly(C₂₋₄-alkylene oxide) chains with at least two groups, which react with isocyanates, which are located at the one end of the chain such that said chains are laterally disposed in relation to the polyurethane polymer backbone, wherein said polyurethane polymer has a number average molecular weight of not less than 2,000 and not greater than 50,000 g/mole which is obtained by reacting together:
1) one or more polyisocyanates having an average functionality of from 2.0 to 2.5;
2) one or more compounds having at least one (C₂₋₄-alkylene oxide) chain and at least two groups, which react with isocyanates, which are located at the one end of the compound such that the poly (C₂₋₄-alkylene oxide) chain is laterally disposed relative to the polyurethane polymer backbone;
3) optionally, one or more compounds having at least one acid group and at least two groups which react with isocyanates;
4) optionally, one or more formative compounds having a number average molecular weight of from 32 to 3,000 g/mole which have at least two groups which react with isocyanates;
5) optionally, one or more compounds which act as chain terminators which contain one group which reacts with isocyanate groups; and
6) optionally, one or more compounds which act as chain terminators which contain a single isocyanate group
wherein component (b) is selected from the group consisting of compound of formula 1, 2, 3, 4, and 6

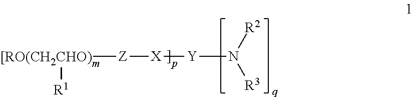

wherein
R is C₁₋₂₀-hydrocarbyl;
R¹ is hydrogen, methyl or ethyl of which not less than 60% is hydrogen;
R² and R³ are each, independently, C₁₋₈-hydroxy alkyl;
Z is C₂₋₄-alkylene;
X is —O— or —NH—;
Y is the residue of a polyisocyanate;
m is from 5 to 150;
p is from 1 to 4; and
q is 1 or 2

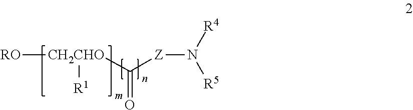

wherein
R⁴ is an isocyanate-reactive organic radical;
R⁵ is hydrogen or an isocyanate-reactive radical; and
n is 0 or 1

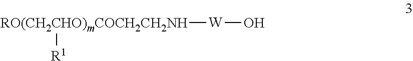

wherein
W is C₂₋₆-alkylene

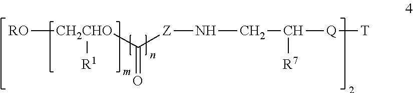

wherein
R⁷ is hydrogen, halogen or C₁₋₄ alkyl;
Q is a divalent electron withdrawing group;
T is a divalent hydrocarbon radical which may contain heteroatoms;

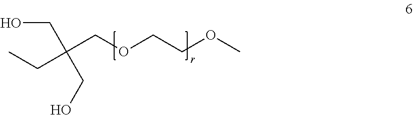

wherein
r is from 4 to 100.

The composition of any preceding paragraph, wherein component (a) is a diisocyanate.

The composition of any preceding paragraph, wherein component (b) is a compound of formula 1

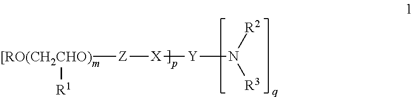

wherein
R is C₁₋₂₀-hydrocarbyl;
R¹ is hydrogen, methyl or ethyl of which not less than 60% is hydrogen;
R² and R³ are each, independently, C₁₋₈-hydroxy alkyl;
Z is C₂₋₄-alkylene;
X is —O— or —NH—;
Y is the residue of a polyisocyanate;
m is from 5 to 150;
p is from 1 to 4; and
q is 1 or 2.

The composition of any preceding paragraph, wherein the alkylene oxide polyurethane wherein Z is ethylene, R¹ is hydrogen and X is —O— and p and q are both 1.

The composition of any preceding paragraph, wherein R² and R³ are both hydroxyethyl.

The composition of any preceding paragraph wherein component (b) is a compound of formula 2

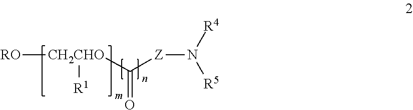

wherein
R is C₁₋₂₀-hydrocarbyl;
R¹ is hydrogen, methyl or ethyl of which not less than 60% is hydrogen;
Z is C₂₋₄-alkylene;
m is from 5 to 150;
R⁴ is an isocyanate-reactive organic radical;
R⁵ is hydrogen or an isocyanate-reactive radical; and
n is 0 or 1.

The composition of any preceding paragraph wherein n is zero, Z is 1,2-propylene, R⁴ is 2-hydroxyethyl and R⁵ is hydrogen.

The composition of any preceding paragraph wherein n is zero, Z is 1,2-propylene and R⁴ and R⁵ are both 2-hydroxyethyl.
14. A polyurethane as described in any preceding paragraph wherein component (b) is a compound of formula 3

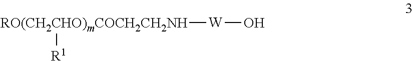

wherein
R is C₁₋₂₀-hydrocarbyl;
R¹ is hydrogen, methyl or ethyl of which not less than 60% is hydrogen; m is from 5 to 150; and
W is C₂₋₆-alkylene.

The composition of any preceding paragraph wherein component (b) is a compound of formula 4

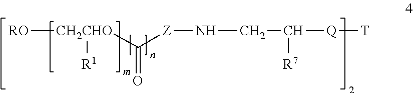

wherein
R is C₁₋₂₀-hydrocarbyl;
R¹ is hydrogen, methyl or ethyl of which not less than 60% is hydrogen;
Z is C₂₋₄-alkylene;
R⁷ is hydrogen, halogen or C₁₋₄ alkyl;
Q is a divalent electron withdrawing group;
T is a divalent hydrocarbon radical which may contain heteroatoms; and
n is 0 or 1.

The composition of any preceding paragraph wherein component (b) is obtained by reacting two moles of a poly (alkylene oxide) monoalkyl ether monoamine with one mole of a compound of formula 5

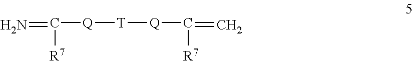

wherein
R′, Q and T are as defined in any preceding paragraph.

The composition of any preceding paragraph wherein component (b) is a compound of formula 6

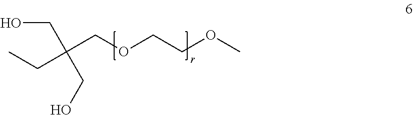

wherein
r is from 4 to 100.

The composition of any preceding paragraph wherein component (c) is a compound of formula 7

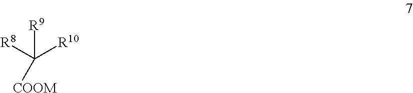

wherein, at least two of the groups R⁸, R⁹ and R¹⁰ are C₁₋₆-hydroxy alkyl and the remainder is C₁₋₆-hydrocarbyl and M is hydrogen, an alkali metal cation, ammonium or quaternary ammonium cation.

The composition of any preceding paragraph wherein the number average molecular weight of the alkylene oxide polyurethane is not less than 2,000 and not greater than 20,000 g/mole.

The composition of any preceding paragraph, wherein the dispersant consists essentially of, or consists of the at least one dihydrocarbydithiophosphoric acid.

The composition of any preceding paragraph, wherein R₁ and R₂ of the dihydrocarbyldithiophosphoric acid or salt are the same and comprises at least one of 1-naphthol, 2naphthol, phenol, chlorophenol, bromophenol, nitrophenol, methoxyphenol, cresol, propylphenol, heptylphenol, octylphenol, decyl phenol, or dodecyl phenol.

The composition of any preceding paragraph, wherein R₁ and R₂ of the dihydrocarbyldithiophosphoric acid or salt are the same and comprises at least one of isobutyl and n-amyl alcohols; sec-butyl and n-amyl alcohols; propyl and n-hexyl alcohols; isobutyl alcohol, n-amyl alcohol, 2-methyl-1-propanol, and 2-methyl-1-butanol.

The composition of any preceding paragraph, wherein the dihydrocarbyldithiophosphoric acid or salt is a salt and X comprises sodium, potassium, lithium, magnesium, calcium, ammonium or mixtures thereof.

The composition of any preceding paragraph, wherein n of the dihydrocarbyldithiophosphoric acid or salt is equal to 2.

The composition of any preceding paragraph, wherein the dispersant comprises, consists of, consists essentially of, a cationic homopolymer.

The composition of any preceding paragraph, wherein the dispersant comprises, consists of, consists essentially of, a cationic copolymer.

The composition of any preceding paragraph, wherein the dispersant comprises, consists of, consists essentially of, an amphoteric homopolymer.

The composition of any preceding paragraph, wherein the dispersant comprises, consists of, consists essentially of, an amphoteric copolymer.

The composition of any preceding paragraph, wherein the dispersant comprises, consists of, consists essentially of, a cationic polymer of a dialkyl diallyl ammonium salt.

The composition of any preceding paragraph, wherein the dispersant comprises, consists of, consists essentially of, a cationic polymer of a dimethyl diallyl ammonium chloride.

The composition of any preceding paragraph, wherein the dispersant comprises, consists of, consists essentially of, a cationic copolymer of dimethyl diallyl ammonium chloride and an acrylamide.

The composition of any preceding paragraph, wherein the dispersant comprises, consists of, consists essentially of, a cationic copolymer of dimethyl diallyl ammonium salt and acrylic acid.

The composition of any preceding paragraph, wherein the dispersant comprises, consists of, consists essentially of, a cationic copolymer of dimethyl diallyl ammonium salt, acrylamide, and acrylic acid

The composition of any preceding paragraph, wherein the cationic polymer has an average molecular weight of between 75,000 and 500,000 as determined by gel permeation chromatography.

The composition of any preceding paragraph, wherein the cationic polymer has an average molecular weight of between 1,000,000 and 1,500,000 as determined by gel permeation chromatography.

The composition of any preceding paragraph, wherein the dispersant comprises, consists of, consists essentially of, a cationic homopolymer of methacrylamide alkyl quaternary ammonium salt.

The composition of any preceding paragraph, wherein the dispersant comprises, consists of, consists essentially of, a cationic homopolymer of methacrylamidopropyltrimethylammmonium chloride.

The composition of any preceding paragraph, wherein the dispersant comprises, consists of, consists essentially of, a cationic copolymer of methacrylamidopropyltrimethylammmonium chloride and acrylic acid.

The composition of any preceding paragraph, wherein the dispersant comprises, consists of, consists essentially of, a cationic copolymer of methacrylamidopropyltrimethylammmonium chloride and acrylamide.

The composition of any preceding paragraph, wherein the dispersant comprises, consists of, consists essentially of, a cationic copolymer of a methacrylamide alkyl quaternary ammonium salt, acrylic acid and acrylamide.

The composition of any preceding paragraph, wherein the dispersant comprises, consists of, consists essentially of, a cationic copolymer of methacrylamidopropyltrimethylammonium chloride, dimethyl diallyl ammonium chloride, and acrylic acid.

A process to produce the composition of any preceding paragraph, comprising,
a. blending a mixture of graphene platelets, at least one dispersant selected from at least one of the carboxyl containing interpolymer, derivatized polycarboxylate dispersant, imide polymer, polyurethane resin, dihydrocarbyl dithiophosphoric acid, and water,
b. subjecting the blend to mechanical or chemical exfoliation.

The process of the preceding paragraph, wherein the exfoliation comprises shear force.

The process of the preceding two paragraphs, wherein the exfoliation comprises ultra-sonication.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A composition comprising
a. a graphene platelet
b. a dispersant selected from at least one of
i. imide polymers comprising a polymer chain having at least one fused aromatic imide pendant group, wherein the polymer is represented by formula (1): 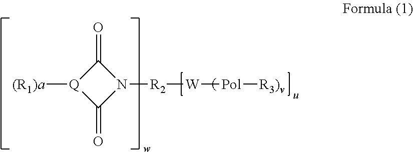
wherein each variable is independently
R₁ is a substituent on Q ring in any position available for bonding to a substituent group and R₁ is independently represented by at least one electron withdrawing group;
a is 1 or 2, or 1;
W is oxygen, sulphur, >NH, or >NG;
R₂ is a C₁ to C₂₀, or C₁ to C₁₂, or C₁ to C₆ hydrocarbylene group;
R₃ is H or C₁₋₅₀ (or C₁₋₂₀)-optionally substituted hydrocarbyl group that bonds to a terminal oxygen atom of the polymer chain forming a terminal ether or terminal ester group and may or may not contain a group capable of polymerization such as a vinyl group, or C₁₋₅₀ (or C₁₋₂₀)-hydrocarbonyl group (i.e., a hydrocarbyl group containing a carbonyl group) that bonds to the oxygen atom of the polymer chain forming a terminal ester group or terminal urethane group and may or may not contain a group capable of polymerization such as a vinyl group, and the substituent is halo, ether, ester, or mixtures thereof;
Pol is a homopolymer chain of ethylene oxide or a copolymer chain of ethylene oxide, wherein the ethylene oxide constitutes 40 wt % to 99.99 wt % of the copolymer chain and where in the polymer chain is selected from the group consisting a poly(ether), poly(ester) and mixtures thereof
u=1 to 3;
v=1 to 2;
w=1 to 3
v=2 when W=>NG;
v=1 when W=Oxygen, Sulphur, or >NG;
G is a hydrocarbyl group containing 1 to 200, or 1 to 100, or 1 to 30 carbon atoms; and
Q is a fused aromatic ring containing 4n+2 π-electrons, wherein
n=2 or more, and Q is bonded to the imide group in such a way to form a 5 or 6 membered imide ring
ii. alkylene oxide polyurethane polymers comprising from 35% to 90% by weight of a poly (C₂₋₄-alkylene oxide) based on the total weight of the polyurethane polymer wherein not less than 60% by weight of the total poly (C₂₋₄-alkylene oxide) is poly (ethylene oxide) and wherein at least 5% poly (C₂₋₄-alkylene oxide) based on the total weight of the polyurethane polymer is incorporated in lateral chains, which lateral chains are characterized as poly(C₂₋₄-alkylene oxide) chains with at least two groups, which react with isocyanates, which are located at the one end of the chain such that said chains are laterally disposed in relation to the polyurethane polymer backbone, wherein said polyurethane polymer has a number average molecular weight of not less than 2,000 and not greater than 50,000 g/mole and which polyurethane polymer contains from 10 to 180 milli-equivalents of acid groups for each 100 gm polyurethane when the polyurethane polymer contains from 35 to 45% by weight poly (alkylene oxide);
iii. water-dispersible or soluble dihydrocarbyl dithiophosphoric acid or salt having the formula II 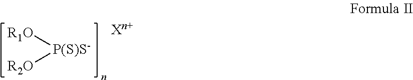
wherein R₁ and R₂ are hydrocarbyl groups containing up to about 18 carbon atoms, n is an integer equal to the valence of X, and Xⁿ⁺ is a dissociating cation,
iv. a cationic or amphoteric homopolymer or copolymer containing at least one of dialkyl diallyl quaternary ammonium salt, methacrylamide alkyl quaternary ammonium salt, acrylic acid, acrylamide, and
c. at least one aqueous or polar solvent.

2. The composition of claim 1, wherein the graphene platelets is in the form of at least one of: mono-layer graphene; multi-layer graphene (2-10 layers); graphite nano-platelets (>10 layers).

3. The composition of claim 1, wherein the graphene platelets have a carbon to oxygen molar ratio of greater than 25:1.

4. The composition of claim 1, wherein the graphene platelets have a carbon to oxygen molar ratio of less than 20:1.

5. (canceled)

6. (canceled)

7. The composition of claim 1, wherein the dispersant consists essentially of, or consists of the at least one imide polymer.

8. (canceled)

9. The composition of claim 1, wherein the dispersant consists essentially of, or consists of the at least one alkylene oxide polyurethane polymer.

10. The composition of claim 1, wherein the dispersant consists essentially of, or consists of the at least one dihydrocarbydithiophosphoric acid.

11. The composition of claim 1, wherein the dispersant consists essentially of or consists of the at least one cationic or amphoteric homopolymer or copolymer containing at least one of dialkyl diallyl quaternary ammonium salt, methacrylamide alkyl quaternary ammonium salt, acrylic acid, acrylamide.

12. A process to produce the composition of any previous claim, comprising,
a. blending a mixture of graphene platelets, at least one dispersant selected from at least one of the imide polymer, dihydrocarbyl dithiophosphoric acid, and water,
b. subjecting the blend to mechanical or chemical exfoliation.

13. The process of claim 12, wherein the mechanical exfoliation comprises shear mixing.

14. The process of claim 12, wherein the mechanical exfoliation comprises ball milling.

15. The process of claim 12, wherein the mechanical exfoliation comprises ultra-sonication.

16. The process of claim 15, wherein the ultra-sonication is applied at 300 to 2000 watts.
